(19) United States
(12) Patent Application Publication
(10) Pub. No.: US 2024/0282941 A1
(43) Pub. Date: Aug. 22, 2024

(54) SINTERED MANGANESE SPINEL BATTERY ELECTRODES

(71) Applicant: University of Virginia Patent Foundation, Charlottesville, VA (US)

(72) Inventors: Gary M. Koenig, JR., Fishersville, VA (US); Cai Chen, Chartottesville, VA (US)

(21) Appl. No.: 18/684,122

(22) PCT Filed: Aug. 15, 2022
(86) PCT No.: PCT/US2022/074982

§ 371 Date: Feb. 15, 2024

Related U.S. Application Data
(60) Provisional application No. 63/233,398, filed on Aug. 16, 2021.

(51) Int. Cl. H01M 4/36; H01M 4/38; H01M 4/505

(52) U.S. Cl. CPC H01M 4/366; H01M 4/38; H01M 4/505

(57) ABSTRACT

According to various aspects, an electrochemical storage device includes a sintered electrode. The sintered electrode includes a doped LiMn₂O₄. The doped LiMn₂O₄ comprises at least 95 wt % of the sintered electrode. Alternatively or in combination, the sintered electrode can include a coated LiMn₂O₄ substrate.

### CROSS-REFERENCE TO RELATED APPLICATION

This application claims the benefit of priority to U.S. Provisional Patent Application Ser. No. 62/233,398 entitled “SINTERED MANGANESE SPINEL BATTERY ELECTRODES,” filed Aug. 16, 2021, the disclosure of which is incorporated herein in its entirety by reference.

### STATEMENT OF GOVERNMENT SUPPORT

This invention was made with government support under Grant Nos. 1652488 and 1825216 awarded by the National Science Foundation. The government has certain rights in the invention.

### BACKGROUND

Lithium ion batteries are widely used in consumer electronics industry due to their high energy density. Electrode active materials are presently under development that can significantly increase the corresponding properties of lithium ion batteries.

### SUMMARY OF THE INVENTION

According to various aspects, an electrochemical storage device includes a sintered electrode. The sintered electrode includes a doped or undoped LiMn₂O₄. The doped or undoped LiMn₂O₄ comprises at least 95 wt % of the sintered electrode. Alternatively or in combination, the sintered electrode can include a coated LiMn₂O₄ substrate.

According to various aspects, an electrochemical storage device sintered electrode includes LiMn₂₋ₓMₓO₄. In which M=Cu, Al, or a mixture thereof and x is in a range of from 0 to 0.16.

According to various aspects, a lithium ion battery includes a sintered electrode including LiMn_{2-x-y}AlₓCu_{y}O₄. In which x and y are independently in a range of from about 0.03 to about 0.13.

According to various aspects a lithium ion battery includes a first electrode that includes a doped or undoped LiMn₂O₄. The doped or undoped LiMn₂O₄ comprises at least 95 wt % of the sintered electrode. The lithium ion battery further includes a second electrode spaced apart from the first electrode. The lithium ion battery further includes an electrolyte in contact with the first electrode and the second electrode. The lithium ion battery further includes a separator positioned between the first electrode and the second electrode.

According to various aspects, a method of making an electrode includes contacting manganese oxalate, lithium carbonate, and at least one dopant, to form a doped or undoped LiMn₂O₄ electroactive material. The method further includes sintering the doped or undoped LiMn₂O₄ material to form the sintered electrode.

According to various aspects, a method of making an electrode includes contacting a first manganese oxalate, a second manganese oxalate that is doped with nickel, a lithium carbonate, and at least one dopant at an elevated temperature, to form a doped, LiMn₂O₄ precursor. The method further includes blending the doped LiMn₂O₄ precursor to form a blended doped LiMn₂O₄ precursor. The method further includes sintering the blended doped LiMn₂O₄ precursor to form the sintered electrode.

According to various aspects, an article includes an electrochemical storage device that includes a sintered electrode. The sintered electrode includes a doped or undoped LiMn₂O₄. The doped or undoped LiMn₂O₄ comprises at least 95 wt % of the sintered electrode. Alternatively or in combination, the sintered electrode can include a coated LiMn₂O₄ substrate.

### BRIEF DESCRIPTION OF THE FIGURES

The drawings illustrate generally, by way of example, but not by way of limitation, various aspects of the present invention.

FIG. 1A is a plot showing primary particle sizes of LiMn₂₋ₓMₓO₄ material in powder form.

FIG. 1B is a plot showing primary particle sizes of LiMn₂₋ₓMₓO₄ material in sintered pellet form.

FIG. 2 is a plot showing powder XRD patterns for the LiMn_{2-x-y}AlₓCu_{y}O₄ material.

FIG. 3 is a plot showing lattice parameters determined from refinement of powder XRD patterns for LiMn₂₋ₓMₓO₄ materials.

FIG. 4 is a plot showing electronic conductivities determined from DC measurements for LiMn₂₋ₓMₓO₄ materials.

FIG. 5 is a plot showing voltage profiles of first discharge at C/20 for LiMn₂₋ₓMₓO₄ materials in composite electrode paired with Li foil anode.

FIG. 6 is a plot showing discharge capacities during rate capability evaluation of the LiMn₂₋ₓMₓO₄ in composite electrodes paired with Li metal anode.

FIG. 7A is a plot showing capacity retention (based on first discharge capacity) of last cycle of rate capability testing for Al-doped LMO.

FIG. 7B is a plot showing capacity retention (based on first discharge capacity) of last cycle of rate capability testing for Cu-doped LMO.

FIGS. 8A-8G are plots showing voltage profiles of first cycle at C/50 (solid) and C/20 (dashed, after five C/50 cycles) for various LiMn₂₋ₓMₓO₄ materials.

FIG. 9 is a plot showing discharge capacities during rate capability evaluation of the LiMn₂₋ₓMₓO₄ in sintered electrodes paired with sintered LTO anode.

FIG. 10A is a plot showing first (solid) and second (dashed) Δ dQ/dV peak positions of the first charge cycle for Al-doped LMO.

FIG. 10B is a plot showing first (solid) and second (dashed) Δ dQ/dV peak positions of the first charge cycle for Cu-doped LMO.

FIG. 11A is a plot showing first cycle coulombic efficiency for Al-doped LMO and (in both sintered electrodes at C/50 (solid) and composite electrode at C/20 (dashed).

FIG. 11B is a plot showing first cycle coulombic efficiency for Cu-doped LMO in both sintered electrodes at C/50 (solid) and composite electrode at C/20 (dashed).

FIG. 12A-12G are a series of plots showing first (solid) and second (dashed) cycle dQ/dV profiles at C/50 for LiMn₂₋ₓMₓO₄ materials in sintered electrode paired with sintered LTO anode.

FIG. 13 is a plot showing the higher voltage dQ/dV peak position of LiMn₂₋ₓCuₓO₄ extracted from the first charge cycle at C/20 of a composite electrode paired with lithium metal.

FIG. 14 is a plot showing lattice parameters determined from refinement of powder XRD patterns for LiMn_{2-x-y}AlₓCu_{y}O₄ materials.

FIG. 15 is a plot showing electronic conductivities determined from DC measurements for LiMn_{2-x-y}AlₓCu_{y}O₄ materials.

FIG. 16 is a plot showing voltage profiles of first discharge at C/20 for LiMn_{2-x-y}AlₓCu_{y}O₄ materials in composite electrode paired with Li foil anode.

FIG. 17 is a plot showing discharge capacities during rate capability evaluation of the LiMn_{2-x-y}AlₓCu_{y}O₄ in composite electrodes paired with Li metal anode.

FIGS. 18A-18C are plots showing voltage profiles of first cycle at C/50 (solid) and C/20 (dashed, after five C/50 cycles) for LiMn_{2-x-y}AlₓCu_{y}O₄ materials in sintered electrode paired with sintered LTO anode.

FIG. 19 is a plot showing discharge capacities during rate capability evaluation of the LiMn_{2-x-y}AlₓCu_{y}O₄ in sintered electrodes paired with sintered LTO anode.

FIG. 20 is a plot showing first (solid) and second (dashed) Δ dQ/dV peak positions of the first charge cycle for LiMn_{2-x-y}AlₓCu_{y}O₄ in sintered electrode cells at C/50.

FIG. 21 is a plot showing the higher voltage dQ/dV peak position of LiMn_{2-x-y}AlₓCu_{y}O₄ extracted from the first charge cycle at C/20 of a composite electrode paired with lithium metal.

FIG. 22 is a plot showing capacity retention (based on first discharge capacity) of last cycle of rate capability testing for LiMn_{2-x-y}AlₓCu_{y}O₄ sintered electrodes at C/50 (solid) and composite electrode at C/20 (dashed).

FIG. 23 is a plot showing first cycle coulombic efficiency LiMn_{2-x-y}AlₓCu_{y}O₄ in sintered electrodes at C/50 (solid) and composite electrode at C/20 (dashed).

FIGS. 24A-24C are plots showing first (solid) and second (dashed) cycle dQ/dV profiles at C/50 for LiMn_{2-x-y}AlₓCu_{y}O₄ materials in sintered electrode paired with sintered LTO anode.

FIG. 25A is a plot showing soluble Mn and Ni concentration as the coprecipitation reaction with oxalate progressed in the absence of inhibitor.

FIG. 25B is a plot showing the fraction of the individual Ni and Mn precipitated based on FIG. 25A.

FIG. 25C is a plot showing soluble Mn and Ni concentration as the coprecipitation reaction with oxalate progressed with 5 mM sodium citrate present.

FIG. 25D is a plot showing the fraction of the individual Ni and Mn precipitated based on (c).

FIG. 26A is a plot showing average Mn:Ni molar ratio determined from EDS on oxalate particles collected at 5, 10, and 30 mins after initiation of the coprecipitation reaction in the presence of inhibitor.

FIG. 26B is a plot showing EDS line scan composition for Mn (squares) and Ni (circles) on a Mn_{0.75}Ni_{0.25}C₂O₄·2H₂O platelet collected at 30 mins and precipitated with inhibitor present.

FIGS. 27A-27D are plots showing voltage profiles for cathode materials paired with Li metal anodes, with the curves taken from the second charge/discharge process at each rate (rates used were C/20, C/10, C/5, C/2, 1C, and 2 C).

FIG. 28A is a CV profile for LMO.

FIG. 28B is a CV profile for Li₄Mn₅O₁₂.

FIG. 28C is a CV profile for LMNO.

### DETAILED DESCRIPTION OF THE INVENTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Electrochemical storage devices such as lithium-ion batteries have become prevalent for portable energy storage. Efforts towards continuing to increase the energy density of batteries, centered on engineering the electrode structure can provide improvements with regards to energy and power density. Sintered electrodes, which have no inactive additives, can achieve high areal loadings of over 150 mg electroactive material cm-2, however, they have electronic and/or ionic transport resistance limitations as the electrode loadings and thicknesses increase. Herein, LiMn₂O₄(LMO) is disclosed as a sintered electrode cathode material. LiMn₂O₄ is attractive as a relatively low cost and Co-free cathode option, but its relatively low electronic conductivity and fading due to Jahn-Teller distortion and/or manganese dissolution pose challenges that are exacerbated in sintered electrodes relative to composites.

One route to increase the energy density in lithium-ion (Li-ion) batteries at the cell level is to increase the electrode thickness, because thicker electrodes result in greater relative fractions of the cell being electroactive material which stores/delivers energy. However, as electrodes are made thicker, one challenging limitation is that ionic transport pathways become much longer resulting in substantial polarization and reduced rate capability due to depletion of ions in the electrode microstructure during charge/discharge. Transport restrictions are exacerbated in thick composite electrodes which have conductive carbon and polymer binder additives, because these inactive species occupy the interstitial regions along with the electrolyte and make the ion pathways more tortuous. For example, relative to ideal hard sphere packing, the increase in the exponent associated with tortuosity (e.g., Bruggeman exponent) for composite electrodes with inactive additives has been reported to be over a factor of 3. To reduce the tortuosity associated with the inactive compounds, routes have been explored to process electrodes free of these additives. One such system includes “sintered electrodes”, where solid electroactive Li-ion battery particles have been pressed together (e.g., via hydraulic compression) and undergo heat treatment resulting in a porous ceramic structure.

Compared to conventional composite electrodes, sintered electrodes typically have relatively high thicknesses (>500 μm), resulting high areal loadings of active material exceeding ˜200 mg cm⁻². Such electrodes reduce inactive mass dedicated to the electrode architecture, alleviate the additional ion transport restrictions associated with these additives, and with increased thickness decreases the relative allocation of other cell components such as separators and current collectors.

Materials such as LiCoO₂ (LCO) are well suited as a cathode material for sintered electrodes because the electronic conductivity is relatively high across a wide range of degrees of lithiation (over 95% of the lithiation range typically accessed in LCO has electronic conductivity over 10⁻¹ S cm⁻¹). However, due to environmental and cost challenges, consideration of alternative cathode materials are disclosed herein for sintered electrodes.

One alternative, described herein is the spinel-phase commercial Li-ion electrode material LiMn₂O₄(LMO). LMO has potential advantages of earth-abundant transition metals, relatively low reported toxicity, and much lower cost than alternatives such as LCO. However, the electronic conductivity of LMO (10⁻⁴ S cm⁻¹-10⁻⁵ S cm⁻¹) is much lower than that of LCO, about 4 orders of magnitude. This low conductivity presents a challenge in its use as a sintered Li-ion cathode material without restricting the operating rate/current density, unless the material can be modified to improve the electronic conductivity. A solution to this potential drawback is to dope LMO or potentially apply a coating to an LMO substrate.

As an example, a sintered electrode can be doped or coated with a metal having a 1⁺, 2⁺, or 3⁺ oxidation state. Non-limiting examples of such metals include copper, aluminum, sulfur, potassium, or a mixture thereof. In some aspects where the metal is a dopant, the sintered electrode can include just one dopant. However, in further aspects the sintered electrode can include a plural number of dopants.

In examples where the sintered electrode has a spinel microstructure that includes a doped LiMn₂O₄, the doped LiMn₂O₄ can be represented by Formula I:

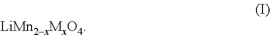

In Formula I, M=Cu, Al, or a mixture thereof. In Formula I, x is in a range of from about 0 to about 0.16, about 0 to about 0.15, about 0 to about 0.10, less than, equal to, or greater than about 0, 0.01, 0.02, 0.03, 0.04, 0.05, 0.06, 0.07, 0.08, 0.09, 0.10, 0.11, 0.12, 0.13, 0.14, 0.15, or about 0.16. In some examples, where the LMO is co-doped with aluminum and copper, the doped LiMn₂O₄ comprises Formula II:

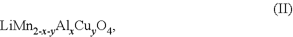

In Formula II, x and y are independently in a range of from about 0.01 to about 0.15, about 0.01 to about 0.13, about 0.01 to about 0.095, less than, equal to, or greater than about 0.01.

Because the electrode is sintered, the LMO composition can account for at least 95 wt % of the sintered electrode, at least 96 wt %, at least 97 wt %, at least 98 wt % at least 99 wt %, or 100 wt % of the sintered electrode. These values are measured prior to the electrode being exposed to an electrolyte solution. Typically, the sintered electrode is formed such that it is free the conductive additives that facilitate electron transport through the sintered electrode matrix in composite electrodes. With the absence of conductive additives, electrons must traverse to/from the current collector through the entire sintered electrode thickness via conduction through the electroactive material itself.

As described above LMO can be doped with one or more metals. Alternatively, an LMO that is free of doping can be coated with the one more metals. The one or more metals can include at least one metal having a 1⁺, 2⁺, or 3⁺ oxidation state. Non-limiting examples of suitable metals for a coating include copper, aluminum, sulfur, potassium, or a mixture thereof. Where present the coating can cover from about 10% to about 100% of a total surface area of the LiMn₂O₄ substrate, about 10% to about 50%, less than, equal to, or greater than about 10%, 15, 20, 25, 30, 35, 40, 45, 50, 55, 60, 65, 70, 75, 80, 85, 90, 95, or about 100% of a total surface area of the LiMn₂O₄ substrate. The coating can be a continuous coating or it can be distributed discontinuously at discrete locations about the sintered LMO electrode.

The sintered electrode can be located in any variety of energy storage devices. For example, the sintered electrode can be located in a lithium ion battery. Lithium ion batteries generally comprise a positive electrode (cathode), a negative electrode (anode), a separator between the negative electrode and the positive electrode and an electrolyte comprising lithium ions. The sintered electrodes are generally associated with metal current collectors, such as metal foils. Lithium ion batteries refer to batteries in which the negative electrode active material is a material that takes up lithium during charging and releases lithium during discharging.

The nature of the positive electrode active material and the negative electrode active material influences the resulting voltage of the battery since the voltage is the difference between the half-cell potentials at the cathode and anode. Suitable positive electrode active materials include the doped or coated LMO compounds described herein. Suitable negative electrode compositions can include, for example, graphite, synthetic graphite, coke, fullerenes, other graphitic carbons, niobium pentoxide, tin alloys, silicon, silicon alloys, silicon-based composites, titanium oxide, tin oxide, and lithium titanium oxide, such as LiₓTiO₂, 0.5<x≤1 or Li₁₊ₓTi₂₋ₓO₄, 0≤x≤⅓. Graphitic carbon and metal oxide negative electrode compositions take up and release lithium through an intercalation or similar process. Silicon and tin alloys form alloys with the lithium metal to take up lithium and release lithium from the alloy to correspondingly release lithium. Negative electrode active materials of particular interest are described in detail below.

The positive electrode active compositions and negative electrode active compositions are free of a polymer binder, owing to being sintered. In non-sintered electrodes, examples of polymer binders include, for example, polyvinylidene fluoride, polyimide, polyethylene oxide, polyethylene, polypropylene, polytetrafluoroethylene, polyacrylates, rubbers, e.g. ethylene-propylene-diene monomer (EPDM) rubber or styrene butadiene rubber (SBR), copolymers thereof, or mixtures thereof. Advantageously, being free of these types of binders allows for a greater energy density in the instantly disclosed lithium ion batteries.

The sintered electrode, in some aspects, can be associated with an electrically conductive current collector to facilitate the flow of electrons between the sintered electrode and an exterior circuit. The current collector can comprise metal, such as a metal foil or a metal grid. In some aspects, the current collector can be formed from nickel, aluminum, stainless steel, copper or the like. The sintered electrode material can be cast as a thin film onto the current collector. The sintered electrode material with the current collector can then be dried, for example in an oven, to remove solvent from the sintered electrode. In some aspects, the dried sintered electrode material in contact with the current collector foil or other structure can be subjected to a pressure, such as, from about 2 to about 10 kg/cm² (kilograms per square centimeter).

The separator is located between the positive sintered electrode and the negative electrode. The separator is electrically insulating while providing for at least selected ion conduction between the two electrodes. A variety of materials can be used as separators. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk.

The electrolyte includes solvated ions as electrolytes, and ionic compositions that dissolve to form solvated ions in appropriate liquids are referred to as electrolyte salts. Electrolytes for lithium ion batteries can comprise one or more selected lithium salts. Appropriate lithium salts generally have inert anions. Suitable lithium salts include, for example, lithium hexafluorophosphate, lithium hexafluoroarsenate, lithium bis(trifluorometh yl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. Traditionally, the electrolyte comprises a 1 M concentration of the lithium salts, although greater or lesser concentrations can be used.

A non-aqueous liquid can be used to dissolve the lithium salt(s). The solvent generally does not dissolve the electroactive materials. Appropriate solvents include, for example, propylene carbonate, dimethyl carbonate, diethyl carbonate, 2-methyl tetrahydrofuran, dioxolane, tetrahydrofuran, methyl ethyl carbonate, γ-butyrolactone, dimethyl sulfoxide, acetonitrile, formamide, dimethyl formamide, triglyme (tri(ethylene glycol) dimethyl ether), diglyme (diethylene glycol dimethyl ether), DME (glyme or 1,2-dimethyloxyethane or ethylene glycol dimethyl ether), nitromethane and mixtures thereof.

The sintered electrodes described herein can be incorporated into various commercial battery designs, such as prismatic shaped batteries, wound cylindrical batteries, coin batteries or other reasonable battery shapes. The batteries can comprise a single sintered electrode stack or a plurality of sintered electrodes of each charge assembled in parallel and/or series electrical connection(s). Appropriate electrically conductive tabs can be welded or the like to the current collectors, and the resulting jellyroll or stack structure can be placed into a metal canister or polymer package, with the negative tab and positive tab welded to appropriate external contacts. Electrolyte is added to the canister, and the canister is sealed to complete the battery. Some presently used rechargeable commercial batteries include, for example, the cylindrical 18650 batteries (18 mm in diameter and 65 mm long) and 26700 batteries (26 mm in diameter and 70 mm long), although other battery sizes can be used.

The sintered electrode can be formed according to many suitable methods. For example, the sintered electrode can be formed by contacting manganese oxalate, lithium carbonate, and the at least one dopant, to form a doped LiMn₂O₄ electroactive material. The manganese oxalate comprises Formula (III),

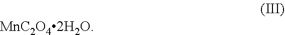

The at least one dopant is in the form of a metal oxide. As a non-limiting example, the metal oxide is CuO, Al₂O₃, or a mixture thereof. If the sintered electrode is a co-doped electrode, the metal oxides can be added substantially simultaneously.

The doped or undoped LiMn₂O₄ electroactive material is then sintered to form the sintered electrode. Sintering can be performed at a temperature in range of from about 500° C. to about 1100° C., about 700° C. to about 900° C., less than, equal to, or greater than about 500° C., 550, 600, 650, 700, 750, 800, 850, 900, 950, 1000, 1050, or about 1100° C. Sintering can be conducted at a constant temperature or at a variable temperature during the sintering process. Sintering can last for any amount of time in a range of from about 0 hours to about 20 hours, about 12 hours to about 18 hours, less than, equal to, or greater than about 0 hours, 1, 2, 3, 4, 5, 6, 7, 8, 9, 10, 11, 12, 13, 14, 15, 16, 17, 18, 19, or about 20 hours. Sintering can be conducted in one step or across multiple sintering steps.

The structure and/or arrangement of pores in the sintered electrode microstructure can lead to additional improvements in the energy and power density of the energy storage device. As an example, aligning the pores can improve these properties. One method that can be used to accomplish this is to fabricate an sintered electrode using reactants that are capable of forming an anisotropic structure. This can be accomplished by producing an anisotropic precipitate particle that includes a single transition metal or multiple transition metals. The precipitate can be used as a precursor template in formulating battery active material having an anisotropic morphology. Any suitable transition metal can be used to form the precursor template.

An example of such a template is represented as a second manganese oxalate that can be is added during the manufacturing process described above or completely substituted for the manganese oxalate described above. The second manganese oxalate comprises Formula IV:

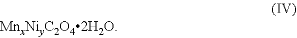

The sum of x and y=1. In some aspects, x is greater than y. A ratio of x:y can be in a range of from about 2:1 to about 4:1. In some aspects, the second manganese oxalate comprises Formula V:

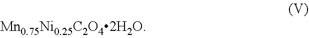

The electrochemical storage device described herein can be disposed in many suitable articles. For example, the electrochemical storage device can be disposed in vehicle (e.g., an electric vehicle) or an electronic device.

The sintered electrode provides numerous advantages. In particular when compared to a composite electrode that includes LMO, the sintered electrode has greater stability. Additionally, the sintered electrode has better discharge capacity. For example, a discharge capacity of the sintered electrode can be in a range of from about 10 mAh g⁻¹ to about 200 mAh g⁻¹, 15 mAh g⁻¹ to about 100 mAh g⁻¹, about 15 mAh g¹ to about 30 mAh g⁻¹, less than, equal to, or greater than about 10 mAh g⁻¹, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199 or about 200 mAh g⁻¹.

### EXAMPLES

Various aspects of the present invention can be better understood by reference to the following Examples which are offered by way of illustration. The present invention is not limited to the Examples given herein.

### Example 1: Al, Cu, and Al+Cu Doped LMO Electrode

Pristine and Doped LiMn₂O₄ Synthesis

To synthesize LiMn₂O₄(LMO) first an Mn oxalate precursor was prepared. 100 mM of sodium oxalate (Na₂C₂O₄, Fisher Chemical) and 10 mM of sodium citrate dihydrate (Na₃C₆O₇H₅·2H₂O, Sigma-Aldrich) were dissolved into 400 mL of deionized (DI) water in a 1000 mL beaker, and separately 100 mM of manganese sulfate monohydrate (MnSO₄·H₂O, Fisher Chemical) was dissolved in 400 mL of DI water in another 1000 mL beaker. Both solutions were preheated to 60° C. before adding the manganese sulfate solution into the oxalate/citrate solution all at once. The precipitation reaction was kept at 60° C. using a stirred hot plate at 300 RPM, and the reaction proceeded for 30 mins. After the 30 mins of reaction, the precipitate was collected by via vacuum filtration, rinsed with 1.6 L of DI water, and dried at 80° C. overnight in an air atmosphere. The resulting precipitate was MnC₂O₄·2H₂O, as has been previously reported using similar methods.

To convert the precursor to electroactive LMO-type battery material, the MnC₂O₄·2H₂O was blended with Li₂CO₃ (Fisher Chemical) for a target molar ratio of 1.05:2 Li:Mn. For cases where the LMO was doped with Cu or Al, in addition to Li₂CO₃ the oxalate precursor was also blended with CuO (Alfa Aesar, for Cu doping) or Al₂O₃(Alfa Aesar, for Al doping) for a target molar ratio 1.05:2−x:x, where x=0, 0.05, 0.1, and 0.15 (dopant level) and the molar ratios represent Li:Mn:Cu or Li:Mn:Al (depending on whether Cu or Al substitution for Mn was targeted). Mortar and pestle were used to mix the powders by hand for 10 minutes before transfer into a furnace (Carbolite CWF 1300). The temperature profile used for calcination was to heat to 900° C. via ramping up the temperature at 1° C. min⁻¹, holding the temperature at 900° C. for 6 h, ramping the temperature down at 1° C. min⁻¹ to 700° C., holding at 700° C. for 10 h, and then ramping the temperature down to 30° C. at a rate of 1° C. min⁻¹. The furnace atmosphere was air. The materials extracted from the furnace were the final electroactive material powders.

### Electrochemical Evaluation

For composite electrode cells, cathodes were processed by mixing the electroactive material powder with acetylene carbon black (CB, Alfa Aesar), and polyvinyl pyrrolidone (PVP, Sigma Aldrich, 360 kDa molecular weight) using ethanol (Fisher) as solvent with a mass ratio of 8:1:1 active material:CB:PVP. Mixing was performed in a slurry mixer (Thinky AR-100) at 2000 RPM for 4 minutes followed by sonication for 5 minutes and then another 4 minutes at 2000 RPM in the slurry mixer. The slurry was casted onto an aluminum foil using a doctor blade with a 400 μm gap height. The loadings for all experiments ranged from 4.4-9.1 mg electroactive material cm⁻². The electrode was dried in air for 30 mins followed by vacuum drying at 50° C. for 1 hour. Circular cathodes were punched from the electrode film with an area of 1.33 cm² before transfer into a glove box filled with argon (<1 ppm H₂O and O₂). Li foil was used as an anode and Celgard 2325 as separator, where the anode and separator were punched into circles with an area of 1.60 cm² and 1.98 cm², respectively. 1.2 M LiPF₆ in 3:7 ethylene carbonate:ethyl methyl carbonate (Gotion) was used as the electrolyte. The components were assembled into coin cells (2032-type) in the glove box and then evaluated electrochemically using a multichannel battery cycler (MACCOR) with a voltage range of 3.5 V to 4.3 V (vs. Li/Li). Charge/discharge rates used for cycling were on a C rate basis, where 1C was calculated assuming 148 mA g⁻¹ of cathode active material, and the indicated rate was used for both charge and discharge for a given cycle.

For sintered electrode cells, electrodes were processed by first mixing the electroactive material with a 1 wt % polyvinyl butyral (PVB) solution (Pfaltz & Bauer) in ethanol with a ratio of 1 g powder per 2 mL solution. The suspension was rigorously blended by hand using mortar and pestle and allowed to dry in air. Note that for sintered cathodes LMO (pristine or doped with the various amounts of Cu or Al) was used as the electroactive material, where for the sintered anodes Li₄Ti₅O₁₂ (LTO, NEI corporation) was used. 0.2 g of PVB-coated powder was then loaded into a circular pellet die (Carver) with an area of 1.33 cm² and pressed at 420 MPa for 2 mins with a hydraulic press (Carver). The pressed pellet was transferred into a box furnace and heated to 700° C. for 1 h for LMO (pristine or doped), and 600° C. for 1 h for LTO, where the ramp rate to the set temperature was 1° C. min⁻¹. After the hold, the furnace was cooled to 30° C. at a rate of 1° C. min⁻¹. Final pellet loadings ranged from 140-150 mg cm⁻² and geometric void/porosity volume fractions were 0.31-0.35 for cathode and 0.39-0.41 for anode after heat treatment. LMO and LTO pellets were adhered to the bottom plate and the spacer of the 2032-type cell, respectively, using a customized carbon paste with mass ratio of 1:1 CB:PVP dissolved in ethanol, where the PVP was dissolved at a 5 wt % concentration in ethanol. The pellets attached to the cell components were dried in air for 30 mins followed by vacuum drying at 50° C. for 1 hour before transfer to the glove box. 1.2 M LiPF₆ in 3:7 ethylene carbonate:ethyl methyl carbonate (Gotion) was used as electrolyte, and glass fiber (Fisher, type G6 circles) was used as separator. The coin cells containing sintered electrodes were evaluated electrochemically using a multichannel battery cycler (MACCOR) with a voltage range of 2.0 V to 2.8 V (cell voltage), where 1C was calculated assuming 148 mA g⁻¹ of cathode active material, and the indicated rate was used for both charge and discharge for a given cycle.

### Material Characterization

Scanning electron micrographs (SEM) were conducted on powders and pellets using a FEI Quantum 650. Powder x-ray diffraction (XRD) patterns for powders were collected using a PANalytical X'pert ProMPD. Rietveld refinements on XRD patterns were performed using FullProf Suite. To determine geometric porosity/void volume fraction, the crystal density was determined from XRD refined parameters which was combined with the measured solid material mass to calculate the solid material volume, and geometric measurements of the pellets with calipers were used to determine the total pellet volume.

For direct current (DC) conductivity measurements, the as-sintered pellets were coated with silver paste (Sigma-Aldrich) and dried at 80° C. for 20 mins. The coated pellets were sandwiched between two stainless steel spacers with diameter of 16 mm and thickness of 0.5 mm, with pressure applied via a clamp. Gamry Reference 600 was used to provide a constant voltage at 10 mV and currents were recorded to calculate the pellet conductivity. The measured conductivities for the pellets were then adjusted by the porosity and tortuosity of the pellet to calculate the material conductivity, where a Bruggeman exponent of 1.5 was assumed.

### Results and Discussions

### Undoped and Doped LMO Material Characterization

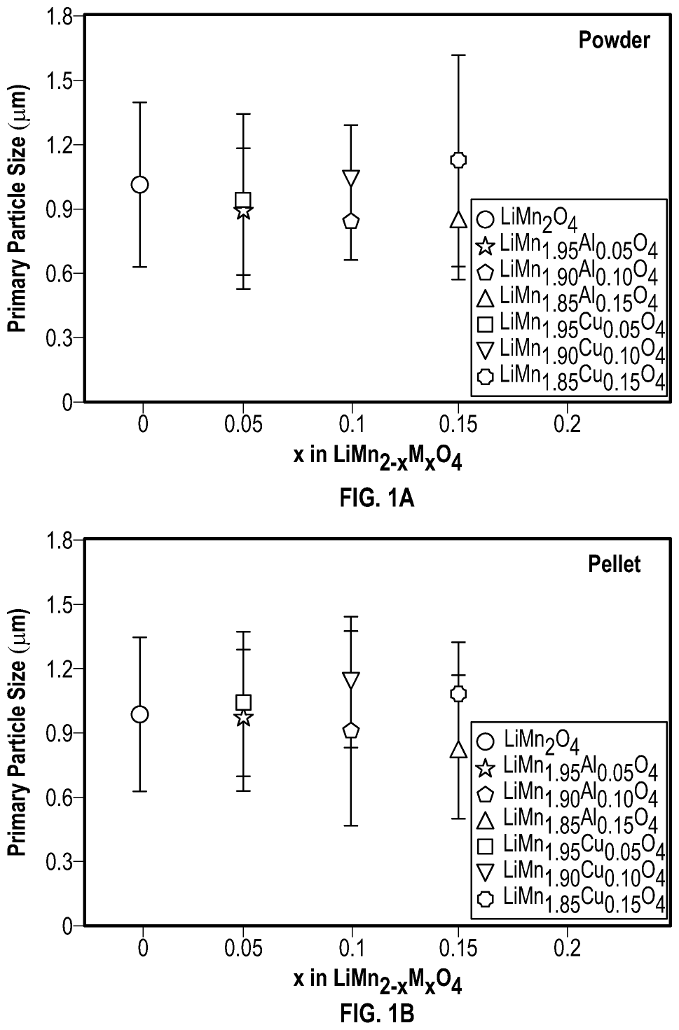

The MnC₂O₄·2H₂O was produced and calcined to form a platelet structure. During the calcination process, water was removed from the structure and the oxalate decomposed to a metal oxide which subsequently reacted with lithium to produce the final active material. The oxalate decomposition and water removal resulted in porous aggregates of primary particles with polydisperse dimensions, although most were between a few hundred nanometers and a couple of micrometers in length. All the pristine, Al-doped and Cu-doped LMO materials had similar primary particle morphology. When processing into sintered electrodes, the powders were hydraulically pressed, resulting in the secondary particles being forced together and the loss of being able to distinguish secondary particle morphologies. The sintering treatment was relatively mild, however, and the primary particle sizes did not undergo noticeable increase in size—although the hydraulic pressing process makes distinguishing between primary particle boundaries more challenging. Primary particle sizes based on the averages of 20 randomly selected particles for each material are shown in figure. 1. The Al-doped samples exhibited slightly smaller average particle sizes, but it is noted that the standard deviations for the particle sizes were relatively large. All materials had average primary particle sizes that fell within a range of 0.5 μm to 1.5 μm, and it was not expected that variations within this size range impacted the electrochemical outcomes for the sintered electrodes, especially when cycling at relatively slow C-rates.

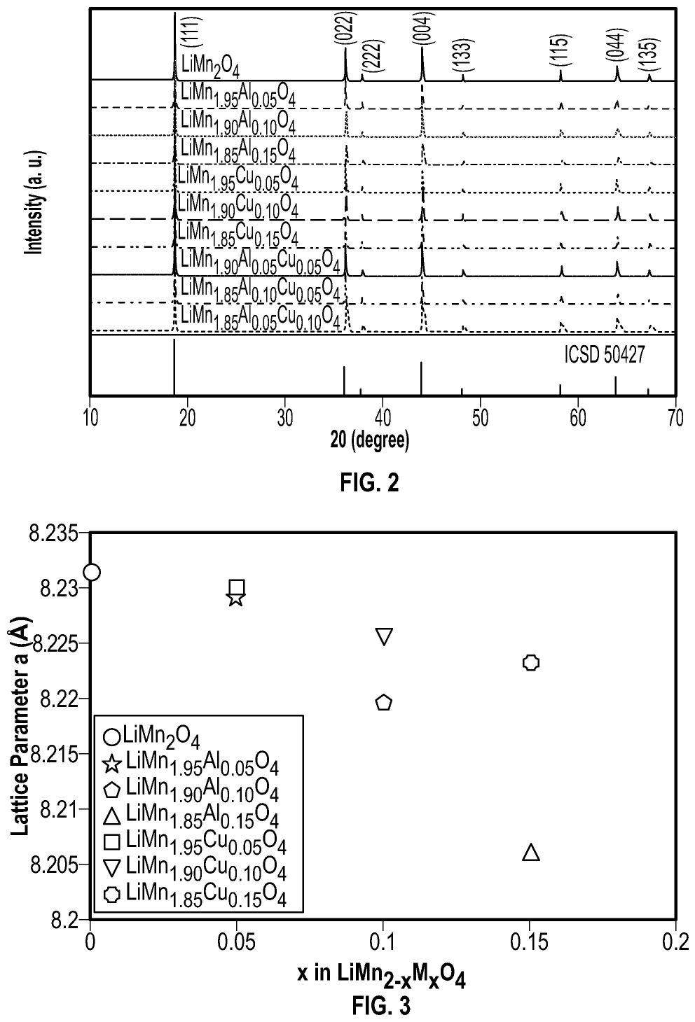

The resulting solid electroactive materials, including pure LMO and all Cu and Al doping levels investigated, had no noticeable impurities from the XRD patterns (FIG. 2). All materials were consistent with the Fd-3m spinel structure. Substitution of Mn with Al or Cu resulted in a decrease in the refined lattice parameter a, as shown in FIG. 3. Herein, the composition will be referred to as LiMn₂₋ₓMₓO₄, where x=0 is pure LMO and for other x values that is the stoichiometry of the dopant M, where M is either Al or Cu. The ionic radii for Al³⁺, Cu²⁺, Mn³⁺, and Mn⁴⁺ are 67.5, 73, 78.5, and 67 μm, respectively. For Al substituted samples, the Al was expected to be Al³⁺ and directly replace Mn³⁺ in the spinel structure. Thus, the observed smaller lattice parameter for increasing Al doping was consistent with the smaller size of Al³⁺ in the structure relative to Mn³⁺. For Cu²⁺ doped samples, every Cu²⁺ substituted into the structure would result in an additional Mn⁴⁺ from Mn³⁺ relative to the undoped LMO material. Thus, increased Cu doping would also be expected to reduce the lattice parameter, and this reduction was also observed—although at the higher dopant extents the Al doping caused greater reductions in the lattice parameter relative to the Cu substitutions.

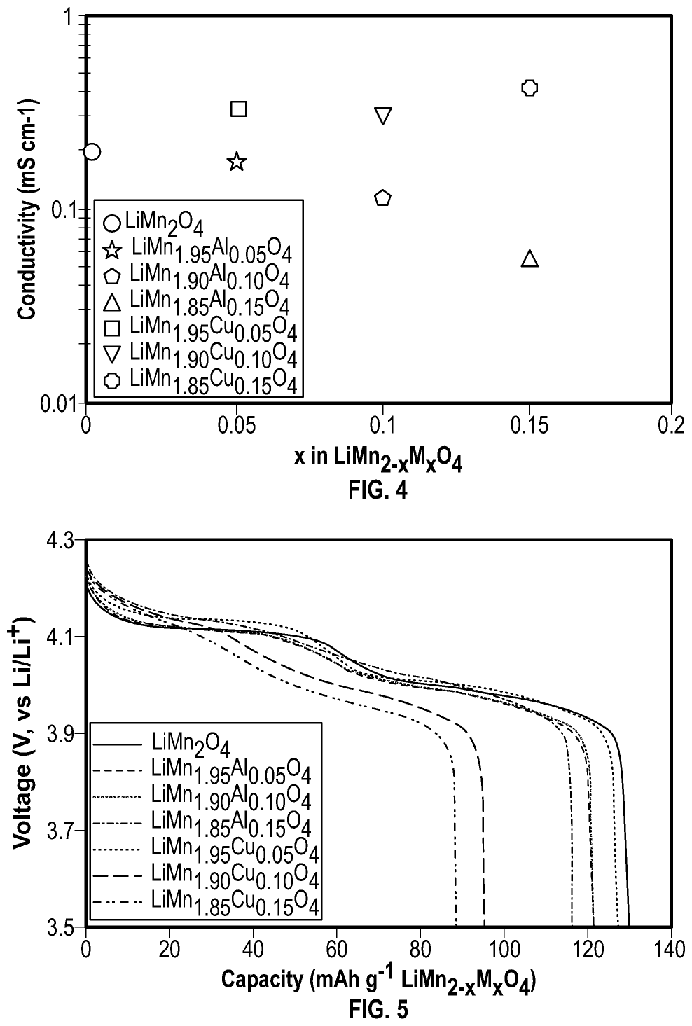

Electronic conductivity for the sintered electrodes of all compositions using DC conductivity measurements are shown in FIG. 4. The undoped LMO had a measured electronic conductivity of 1.9×10⁻⁴ S cm⁻¹. For Al doping, with increasing Al concentration from Al=0 to Al=0.15, the conductivity dropped by ˜76. The electronic conduction in LMO has been reported to be due primarily to the hopping of charge carriers, via electrons in the 3d e_{g} orbital of Mn³⁺ between the Mn³⁺ and Mn⁴⁺ in the spinel structure. Even though doping contracted the lattice which could be favorable for electron hopping, the vacant 3d orbitals due to doping could have made electron hopping across the 16d sites more difficult. In addition, Al³⁺ replacement likely reduced the amount of charge carriers in the 3d e_{g} orbital, which could have caused decreased electronic conductivity. For Cu doping, the electronic conductivity increased by ˜30% from Cu=0 to Cu=0.15, with the increasing conductivity at increased Cu dopant concentrations also consistent with previous reports. Cu²⁺ has 9 electrons in the 3d orbital (with one more to fully fill the orbital), making it an excellent receiver of electrons. Since LMO is a n-type semiconductor, Mn³⁺ replacement by Cu²⁺ with lower 3d states than that of Mn could provide 3d valence e_{g} holes for e_{g} electrons from Mn³⁺ to facilitate charge transport, enhancing electronic conductivity. Another possible supporting perspective is the total electron density of states (DOS), which demonstrated that the Cu substitution could effectively shift the 3d contribution/partial DOS above the Fermi level to the lower energy region, and an additional peak appeared below the Fermi level. Thus, the band gap between the conduction band and valence band was shortened, improving the electronic conductivity.

LiMn₂₋ₓMₓO₄ Electrochemical Evaluation in Composite Electrodes

Before analysis of sintered electrodes comprised of only the electroactive materials, the cathode materials were evaluated in composite electrodes. The composite electrodes contained carbon black, and thus electronic conductivity through the electrode matrix was not expected to have a major impact on electrochemical properties and would enable evaluation of the intrinsic electrochemical capacity of the materials. The first discharge voltage profiles for composite electrodes containing the different active materials at a rate of C/20 is shown in FIG. 5. The dopant-free LMO had the largest capacity of 130 mAh g⁻¹, with two distinct voltage plateaus at ˜4.04 V and ˜4.15 V associated with a single phase reaction between LiMn₂O₄ and Li_{0.5}Mn₂O₄ and a two-phase reaction between Li_{0.5}Mn₂O₄ and λ-MnO₂.

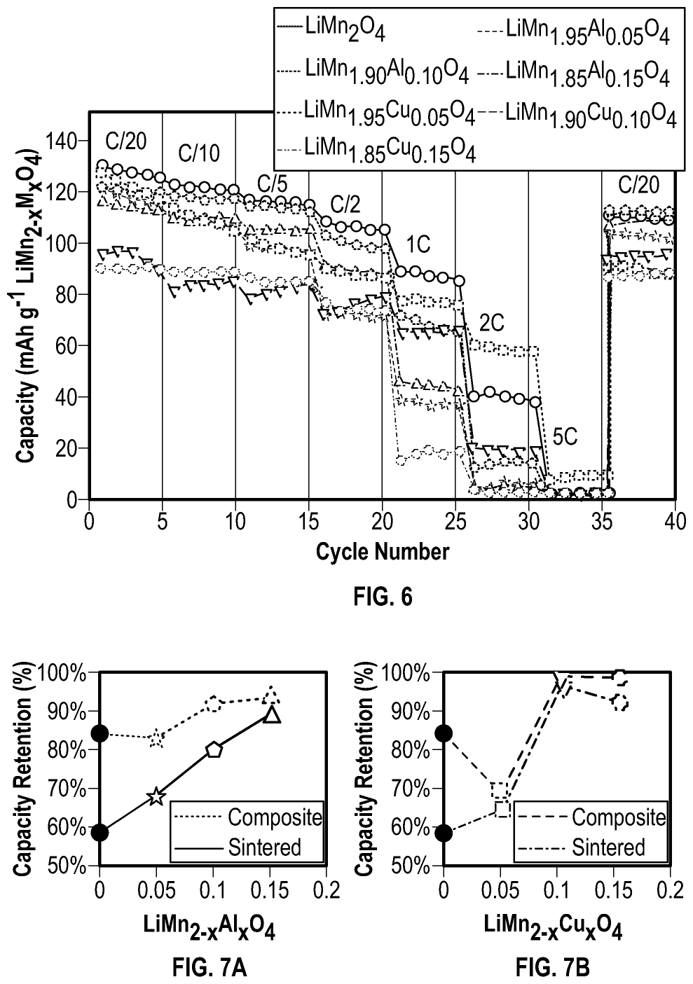

With increasing Al dopant concentration, the discharge capacity decreased. The Al remained in the 3⁺ oxidation state and did not participate in redox chemistry. Thus, every Mn³⁺ substituted for Al³⁺ was a loss of a Mn³⁺ that cannot be oxidized to Mn⁴⁺ during charge (and reversibly reduced back to Mn³⁺ during discharge). The capacity lost for each Mn³⁺ substitution may not exactly match experimental outcomes due to other factors such as defects in the structure, however, the general trend of decreasing capacity with increasing Al³⁺ was observed. Discharge capacity from rate capability testing of the composite electrodes is shown in FIG. 6. The LMO had higher capacity retention at increasing rates up to 1 C compared to any of the Al-doped materials. However, there was capacity fade for the LMO cell, which resulted in the LiMn_{1.9}Al_{0.1}O₄ sample having greater capacity than the dopant-free LMO after returning to the slower C/20 rate after the tests at increasing rates. The capacity retention for the last (40^{th}) cycle increased as the Al dopant concentration increased (FIG. 7A). It is noted that although Al has been reported to reduce the electronic conductivity of LMO, it has also often been added as a dopant in order to suppress the onset of Jahn-Teller distortion which can result in capacity fade. In some cases Al doping can also mitigate Mn dissolution into the electrolyte. In general, Al doping was consistent with previous reports of LMO in composite electrodes where doping with Al reduces initial electrochemical capacity but aids in retaining capacity with cycling.

With increasing Cu dopant concentration, the capacity decreased more than that of Al-doped materials. Due to the relatively low concentration, the majority of the Cu doped into the LMO crystal was expected to have an oxidation state of 2⁺, resulting in even less available Mn³⁺ than that of Al-doped materials. The capacity loss was not strictly linear per Cu substitution, likely due to other factors such as defects, tetrahedral sites (8a) occupied by Cu (ideally tetrahedral sites (8a) are occupied by Li and octahedral sites (16d) by Cu/Mn), and the presence of other Cu oxidation states. At high charge/discharge rate, the capacity retention of LiMn_{1.95}Cu_{0.05}O₄ was the best among all materials, but at even higher Cu concentration rate capability declined. Due to the creation of Mn⁴⁺ by Cu²⁺ substitution, Jahn-teller may be suppressed as would be expected for Al dopants. First principles calculations have also suggested that Cu doping can alleviate Mn dissolution as well. Both LiMn_{1.9}Cu_{0.1}O₄ and LiMn_{1.85}Cu_{0.15}O₄ had almost complete capacity retention on the final cycle of the rate capability testing, although the capacity retention for LiMn_{1.95}Cu_{0.05}O₄ was not as high as pristine LMO.

LiMn₂₋ₓMₓO₄ Electrochemical Evaluation in Sintered Electrodes

Without the electronic conductivity from carbon black in the composite, sintered electrodes comprised of LiMn₂₋ₓMₓO₄ materials relied on electronic conduction though the active material itself for transport of electrons through the electrode matrix. For sintered electrodes, the C-rate was still based on the mass of cathode material but with much larger areal loadings (˜150 mg cm⁻¹) compared to that of the composite electrodes (<10 mg cm⁻¹). Thus, the current densities at C/20 for composite electrodes were more than one order of magnitude smaller than those at C/20 for sintered electrodes.

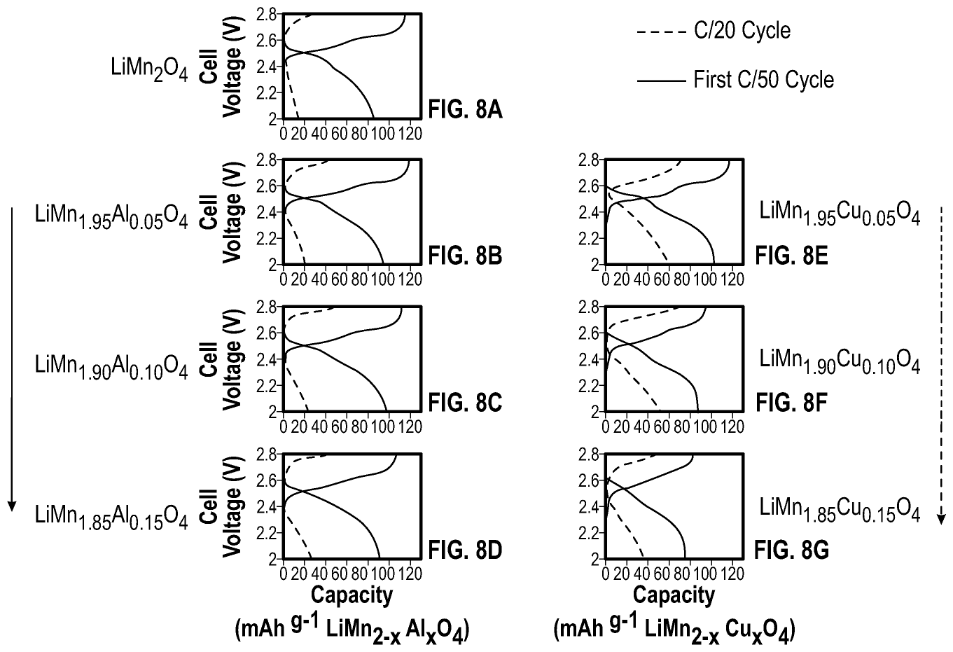

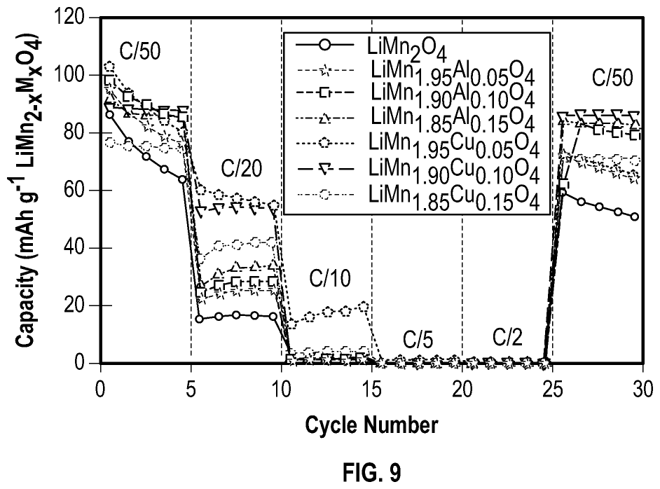

Pristine LMO: The voltage profiles for the first charge and discharge cycles at C/50, and the first charge and discharge cycles at C/20 (the 6^{th} cycle of a rate capability test where the first 5 charge/discharge cycles were at C/50) for pristine, Cu-doped, and Al-doped materials can be found in FIG. 8. All cells were cathode limited in capacity and paired with nominally identical sintered LTO anodes. For pristine LMO at C/50, the first discharge capacity was 86 mAh g⁻¹ LMO, much less than composite electrodes (130 mAh g⁻¹ LMO), and the capacity loss between the first charge and discharge was quite large (29 mAh g⁻¹ LMO for the sintered electrode, and 4 mAh g⁻¹ LMO for the composite electrode). During the charge cycle, two voltage plateaus were present, however they had significant slopes and were not as flat as the composite electrode profiles—even though with the LTO anode in the absence of polarization the charge profiles would still be expected to have flat plateaus. Moreover, during even the initial discharge cycle at the low rate of C/50, an initial more plateaued voltage region at ˜2.5 V was observable, but the second capacity plateau had declined severely. At C/20, the capacity was less than 20 mAh g⁻¹ LMO, and there was almost no capacity at a rate of C/10. The discharge capacities during rate capability evaluation of pristine, Al-doped, and Cu-doped LMO materials is shown in FIG. 9.

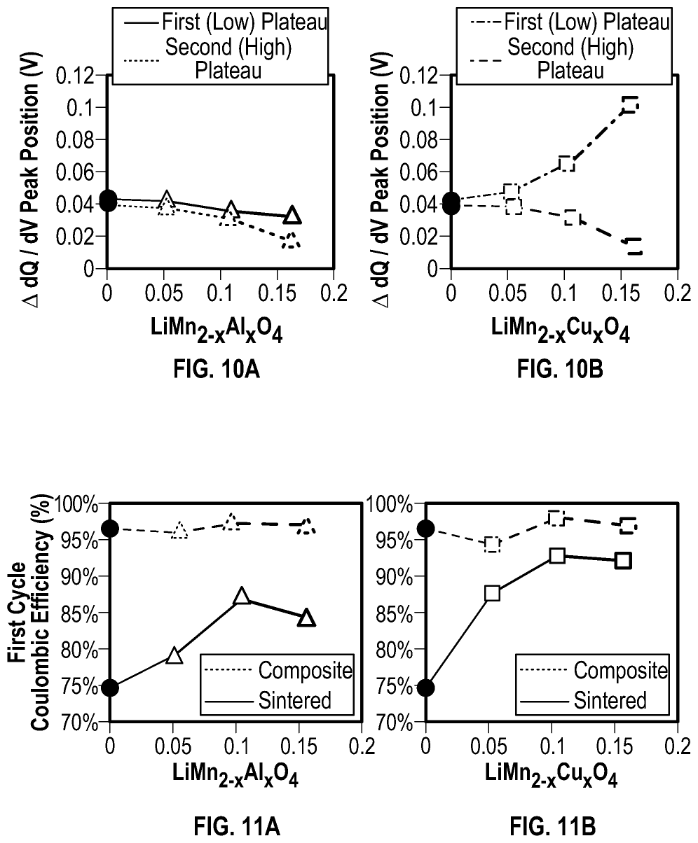

Despite the low electronic conductivity of pristine LMO sintered electrodes, previous reports have indicated that the electronic conductivity of LMO has dependence on the extent of lithiation, and that LMO has increased conductivity when delithiated. The increased conductivity with oxidation of the Mn and removal of Li⁺ has been attributed to the amount of the charge carrier (Mn³⁺ electrons) and the hopping distance between the Mn—Mn. Upon dilithiation, it is thought that the net conductivity change was from the competition between the shortened hopping distance (increasing conductivity) between Mn—Mn and fewer charge carrier Mn³⁺ (decreasing conductivity); the two-phase transition between Li_{0.5}Mn₂O₄ and λ-MnO₂ provided a conduction path of shortened Mn—Mn from the λ-MnO₂ phase and charge carriers from the Li_{0.5}Mn₂O₄ phase. As a result, qualitative analysis of an outcome of the electronic conductivity change was performed by comparing the two Δ dQ/dV peak positions of both sintered (vs LTO) and composite (vs Li foil) cells. The initial charge cycles were used for the analysis to exclude capacity fading issues (arising from Jahn-Teller distortion and/or Mn dissolution, and with an aim to reflect the overpotential differences solely from the electrode electronic conductivity. The Δ dQ/dV peak positions were calculated as described in the following. Composite dQ/dV peak positions were extracted from the initial C/20 charge, where it was assumed there was minimal polarization at this low rate for composite electrodes and any changes in open circuit voltages due to doping were accounted for by only comparing the same materials used in composite and sintered electrodes. Sintered electrode cell dQ/dV peak positions were then extracted and had a value of 1.56 V added to them. This addition accounted for the sintered electrode cells having LTO anodes, where 1.56 V was the difference between the LTO plateau region open circuit voltage (OCV) and Li/Li⁺. Sintered LTO electrodes have a flat OCV as a function of lithiation and high conductivity above ˜10² S m⁻¹ in the lithiation range during most of the charge cycle (˜95% of the LTO). The Δ dQ/dV value was then the difference between the composite material dQ/dV peak position and the adjusted dQ/dV peak position (by LTO OCV) for a sintered electrode of the same material. It was expected that decreased electronic conductivity for an electroactive material would then result in an increase in the Δ dQ/dV value for a material. The Δ dQ/dV peak position associated with the first plateau during charge (at the lower potential) was observed to be greater than the second (FIG. 10). Assuming that this difference was due to the electronic conductivity of the electroactive material (at the slow charge/discharge rate the more common major contributor to polarization of ion transport through the microstructure was not expected to contribute significantly, this result would indicate that the single phase reaction transition (LiMn₂O₄/Li_{0.5}Mn₂O₄) had a lower electronic conductivity than the two-phase transition (Li_{0.5}Mn₂O₄/λ-MnO₂). Such observation was consistent with the observed voltage curve polarization and the offsets between the first charge and discharge capacities at C/50.

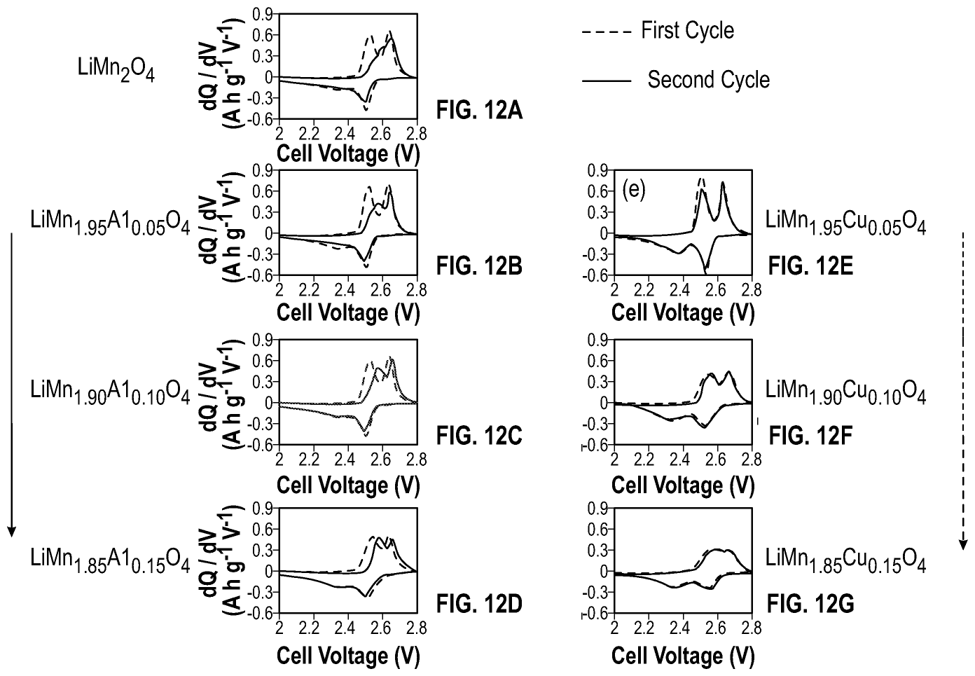

Although direct comparison between the last cycle discharge capacity retention between the composite and sintered cells would be inappropriate because of the significant difference in relative charge/discharge capacities, cycling rates, current densities, and state of charge experienced by the cells, the last cycle retention of capacity of sintered cells relative to the first cycle still may provide insights into the conductivity changes during cycling. For dopant-free LMO the capacity retention for the final cycle was 84% for the composite electrode, but only 58% was achieved for the sintered electrode. The first cycle coulombic efficiencies (CE) of sintered and composite cells were ˜75% and ˜97%, respectively (FIG. 11). In examining the dQ/dV plots for the first two charge cycles (FIG. 12a), the lower voltage peak had decreased intensity on the second cycle, which likely originated due to the undischarged capacity from previous discharge cycle, which may have been due to the variable (and reduced) conductivity described earlier. Both dQ/dV peak positions from the charge process shifted towards higher voltage on the second cycle relative to the first, suggesting an increased overall resistance in addition to the lithiation-dependent electronic conductivity. It was speculated that these results were caused by either: (i) the sintered electrode had much greater active material surface area than that of composite electrode, and thus the Mn dissolution caused by HF attack was more severe, or (ii) during discharge, the Jahn-Teller distortion resulted in tetragonal phase formation at the surface of the electrode material in the operating voltage above ˜3.5 V, which would have orders of magnitude lower electronic conductivity than the pristine spinel phase. Thus, during discharge, the electronic conductivity of LMO could be even lower, compared to the charge process, collectively from both the Jahn-Teller distortion and lithiation dependent electronic conductivity mentioned above.

Al-doped LMO: For all Al-doped LMO sintered electrodes, the first C/50 discharge capacities were greater than that of pristine LMO, and the irreversible first cycle capacity loss between charge and discharge was much smaller (FIGS. 8b-d). At C/20 charge/discharge rate, the discharge capacities were slightly greater than 20 mAh g¹, which were slightly greater than that of the pristine LMO. When looking at the Δ dQ/dV peak positions, with increasing Al concentration, both peaks, especially the second peak associated with the higher voltage charging plateau, shifted to lower differences (FIG. 9a), suggesting a lithiation dependent electronic conductivity where the Al-doped LMO became more electronically conductive during dilithiation relative to pristine LMO. It was possible that increased electronic conductivity during the two-phase transition relative to pristine LMO originated from the contracted crystal lattice resulting from the Al doping. Al-doped LMO exhibits two-phase features (the presence of both Li_{0.5}Mn₂O₄ phase to provide charge carriers and λ-MnO₂ phase to provide shortened electron hopping distance) during charge similar to pristine LMO, and upon dilithiation the Mn—Mn distance would be further shortened compared to the pristine LMO due to the lattice contraction from Al substitution. The competition between charge carriers and hopping distance was likely dominated by the latter despite the reduced charge carriers due to the replacement of Mn³⁺ by Al³⁺. Thus, even though the original sintered electrode Al-doped materials had lower electronic conductivity than that of pristine LMO, the higher capacity, first cycle CE, capacity retention, and rate capability of the same Al-doped electrodes may have resulted due to the increased electronic conductivity after the material started the dilithiation process.

As the Al concentration was increased for the Al-doped LMO sintered electrodes, the capacity retention for the last cycle in the rate capability experiments increased (FIG. 7a). As mentioned before, it was speculated that the inhibited Jahn-Teller distortion and Mn dissolution processes resulted in capacity retention increasing from 58% to 89% for LiMn₂O₄ compared to LiMn_{1.85}Al_{0.15}O₄. The first cycle CEs of the composite cells did not change much (±1%), but the sintered cells had noticeable improvement and reached 87% first cycle coulombic efficiency for LiMn_{1.9}Al_{0.1}O₄ compared to 75% without doping (Supporting Information, FIG. 11). When looking at the dQ/dV plots for the first two cycles (FIGS. 12b-d), decreases in the intensity of the first (lower voltage) charge peak intensity was mitigated with increasing Al concentration. This could be explained by the increased electronic conductivity in the lower voltage plateau region because during the previous discharge cycle greater electronic conductivity would allow greater extents of lithiation and more delivered capacity. The shifting of both dQ/dV charge peaks towards higher voltage, which was an indicator of increased overall polarization discussed above, was slightly suppressed possibly from the inhibition of Mn dissolution and Jahn-Teller distortion.

Cu-doped LMO: The Cu-doped LMOs had the smallest irreversible first cycle capacity loss between the first charge and discharge cycles among pristine, Al-doped, and Cu-doped samples in this study (FIGS. 8e-g). LiMn_{1.95}Cu_{0.05}O₄ had the greatest initial C/50 discharge capacity of over 100 mAh g⁻¹ and achieved ˜ 60 mAh g⁻¹ at C/20. When looking at the Δ dQ/dV peak positions (FIG. 10b), the first (lower voltage) peak shifted to increased values while the second (higher voltage) peak shifted towards decreased values. This result indicated that as Cu concentration increased the electronic conductivity of the single-phase transition decreased while the two-phase transition increased. The conductivity decrease in the single-phase transition was contrary to the pristine and Al-doped LMO, which may have been due to the reduction of charge carriers (two Mn³⁺ were lost for every one Cu²⁺ doped). Also, compared to substitution with Al³⁺ the cell contraction was not as pronounced suggesting the competition between expected factors that influenced the conductivity was dominated by the number of charge carriers rather than the mildly reduced hopping distance. Thus, for the Cu-doped materials the more electronically conductive pathways were not available until the two-phase reaction. Once the reaction proceeded to the two-phase transition, a strong decreasing trend of Δ dQ/dV peak positions was observed with increasing Cu content. This indicated the greatest electronic conductivity increase occurred in the two-phase transition region. The increased electronic conductivity may be explained from the creation of pathways for electron hopping from the contracted cell lattice, supported by DOS calculations from Liu et al using first principles which found an even shorter band gap between the conduction band and valence band after dilithiation.

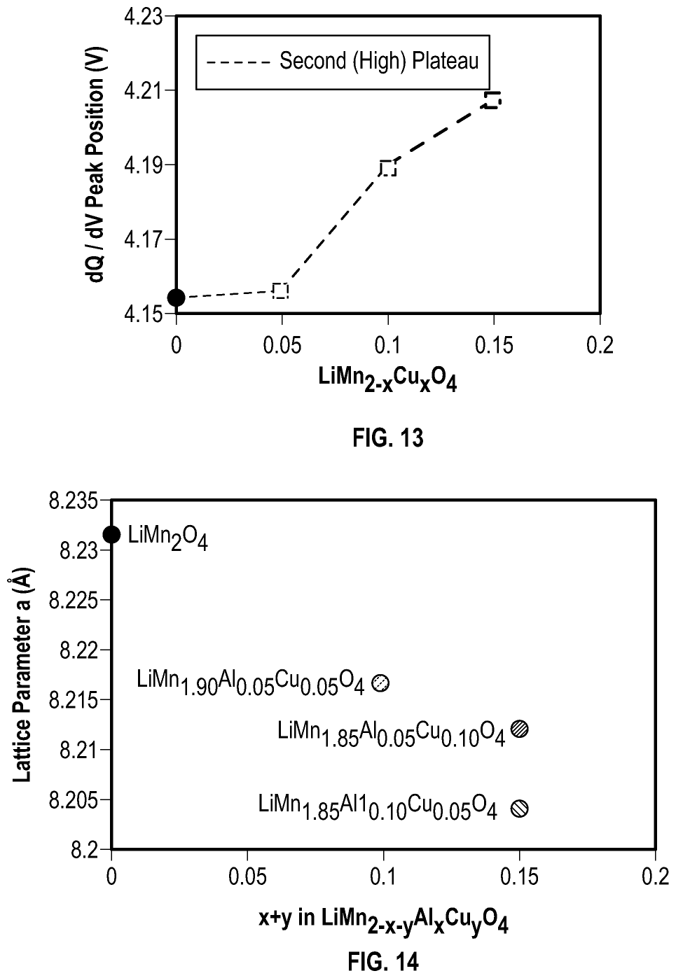

In summary, the Δ dQ/dV analysis suggested the electronic conductivity of Cu-doped LMO upon dilithiation decreased until the two-phase transition, and then increased relative to pristine LMO. Such conductivity trends agreed with the charging voltage profiles at C/20 (FIG. 8e-g), where the lower voltage plateau regions kept shifting upwards indicating increased polarization as the Cu concentration increased. For LiMn_{1.95}Cu_{0.05}O₄ the low voltage plateau initiated at ˜ 2.6 V, and two voltage plateaus were observable; for the LiMn_{1.9}Cu_{0.1}O₄ the charge process initiated at ˜ 2.7 V and the higher voltage plateau was not as wide of a capacity region; for the LiMn_{1.85}Cu_{0.15}O₄ the charge processes initiated over 2.7 V and there was not a clear higher voltage plateau. Even though LiMn_{1.9}Cu_{0.1}O₄ already proceeded to the higher conductivity region at the higher voltage plateau, the plateau capacity was reduced and the curve was sloped. This was rationalized by the observation that the A dQ/dV decreased at the higher voltage plateau region (˜10 mV), but the dQ/dV higher voltage peak for the composite electrode had increased (˜35 mV, shown in FIG. 13). Thus, although the Δ dQ/dV indicated improved conductivity, the redox potential for the material had shifted to a higher voltage and thus less capacity would be accessible for the same cutoff voltage at 2.8 V. The sharp increase in the dQ/dV peak positions at Cu=0.10 could have resulted from increased relative Cu substitution at the Mn site (16d) relative to the Li site (8a) for the increase in total Cu doping. If that occurred, it could account for the shift in the dQ/dV peak position in the composite electrode. As a result, the LiMn_{1.95}Cu_{0.05}O₄ delivered the greatest capacity since it was least affected by the electronic conductivity of the lower voltage plateau and because the voltage for oxidizing the material was intrinsically lower compared to the higher Cu substituted materials, enabling more capacity to be extracted during the charge cycle because the same cutoff voltage was always applied.

When looking at the retention of capacity of the last cycle from the rate capability analysis of the sintered electrodes (FIG. 7b), the Cu-doped LMOs generally had improved stability relative to pristine LMO. For example, the LiMn_{1.9}Cu_{0.1}O₄ retained over 96% of its initial discharge capacity, the best retention among pristine, Al-doped, and Cu-doped sintered electrodes. The LiMn_{1.95}Cu_{0.05}O₄ had little improvement relative to pristine LMO possibly due to the Cu being substituted into the 8a position at higher relative amounts to 16d positions at that level of substitution. CuMn₂O₄ may not have reduced the Jahn-Teller impacts and Mn dissolution which was also likely the source of lower capacity retention for unsubstituted LiMn₂O₄. Compared to Al-doped materials, the first cycle CEs of Cu-doped materials improved notably and reached a maximum at LiMn_{1.9}Cu_{0.1}O₄ with 93% (FIG. 11). In examining the dQ/dV of the first two cycles, the lower voltage peak from dQ/dV during the charge cycle had less of a decrease in intensity from the first to the second cycle for the Cu-doped materials relative to the Al-doped materials (FIG. 12). The retention of the intensity of the first charge peak was despite the lower conductivity of the Cu-doped materials for the first plateau region during charge (inferred from the results in FIG. 6). One explanation for this outcome was that the Al-doped materials were unable to fully discharge their capacity. The dQ/dV plots (FIG. 12) suggested that the differential capacity was approximately zero well before the lower cutoff voltage for the Cu-doped materials, but had not reached zero for the Al-doped materials. This may have been due to the lower conductivity for Al-doped materials relative to Cu-doped materials as they approach full lithiation (FIG. 4), which could be another cause to the improvement in the first cycle CEs (Supporting Information, Figure S6). Also, compared to the Al-doped materials, the dQ/dV peak shift between the first two cycles decreased significantly with increasing Cu doping levels (FIG. 12e-g), which may have been due to the suppression of Jahn-Teller distortion and/or Mn dissolution with increasing Cu substitution.

Al and Cu Co-Doped LiMn_{2-x-y}AlₓCu_{X}O₄ Characterization and Electrochemical Evaluation

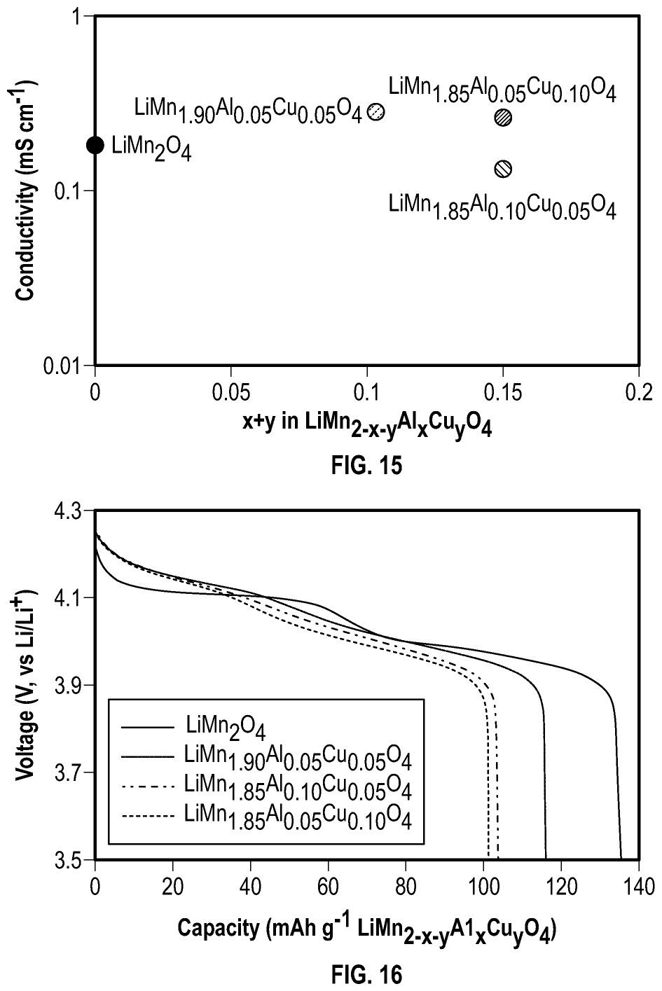

Motivated by combining the merits of both Al and Cu doping, Al and Cu co-doped materials were also explored. No obvious impurity peaks appeared in the XRD patterns for these materials (FIG. 2). The refined lattice parameters can be found in FIG. 14. All the co-doped materials demonstrated smaller lattice parameters relative to pristine LMO, similar to observations for the materials doped with Al or Cu in isolation. LiMn_{1.85}Al_{0.10}Cu_{0.05}O₄ had a slightly smaller lattice parameter than that of LiMn_{1.85}Al_{0.05}Cu_{0.10}O₄, which followed the trend where at the same level of dopant concentration, the Al doping had a smaller lattice parameter than Cu doping. Interestingly, the LiMn_{1.90}Al_{0.05}Cu_{0.05}O₄ and LiMn_{1.85}Al_{0.10}Cu_{0.05}O₄ had the smallest lattice parameter among the materials with dopant concentrations of 0.10 and 0.15, which may have been due to other factors such as crystal defect densities or inhomogeneous distribution of two dopants. As for electronic conductivities, a trend was observed where electronic conductivity increased with additional Cu and decreased with additional Al. All co-doped materials contained Cu, however, and correspondingly all co-doped materials had greater electronic conductivity than pristine LMO (FIG. 15).

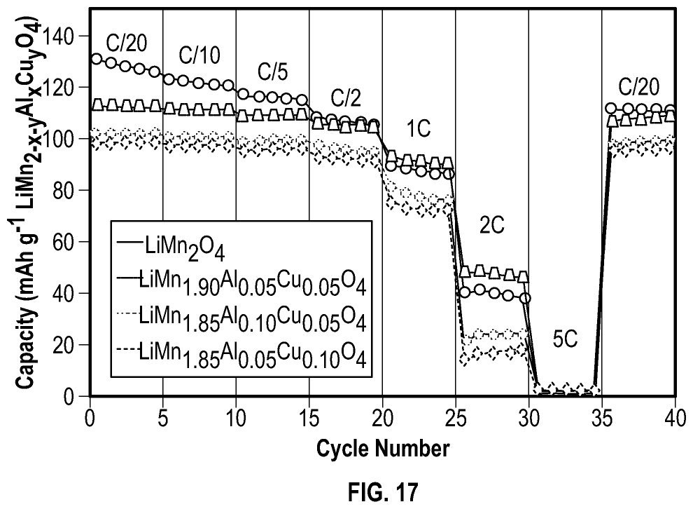

For the composite electrode evaluations, as the total doping concentration increased for co-doped materials, the discharge capacity decreased as expected and discussed earlier. The first discharge voltage curves are shown in FIG. 16. All co-doped samples exhibited more sloped voltage curves, which was more similar to the Cu-doped materials. LiMn_{1.90}Al_{0.05}Cu_{0.05}O₄ reached 119 mAh g⁻¹, which was slightly lower than LiMn_{1.9}Al_{0.1}O₄ (122 mAh g⁻¹) but higher than LiMn_{1.9}Cu_{0.1}O₄ (96 mAh g⁻¹). The LiMn_{1.85}Al_{0.10}Cu_{0.05}O₄ and LiMn_{1.85}Al_{0.05}Cu_{0.10}O₄ reached ˜100 mAh g⁻¹ and 98 mAh g⁻¹, respectively and qualitatively followed the trend seen for the individually doped samples that for the same amount of doping concentration, Cu doping decreased the capacity more than Al doping in composite electrodes. Rate capability tests are shown in FIG. 17.

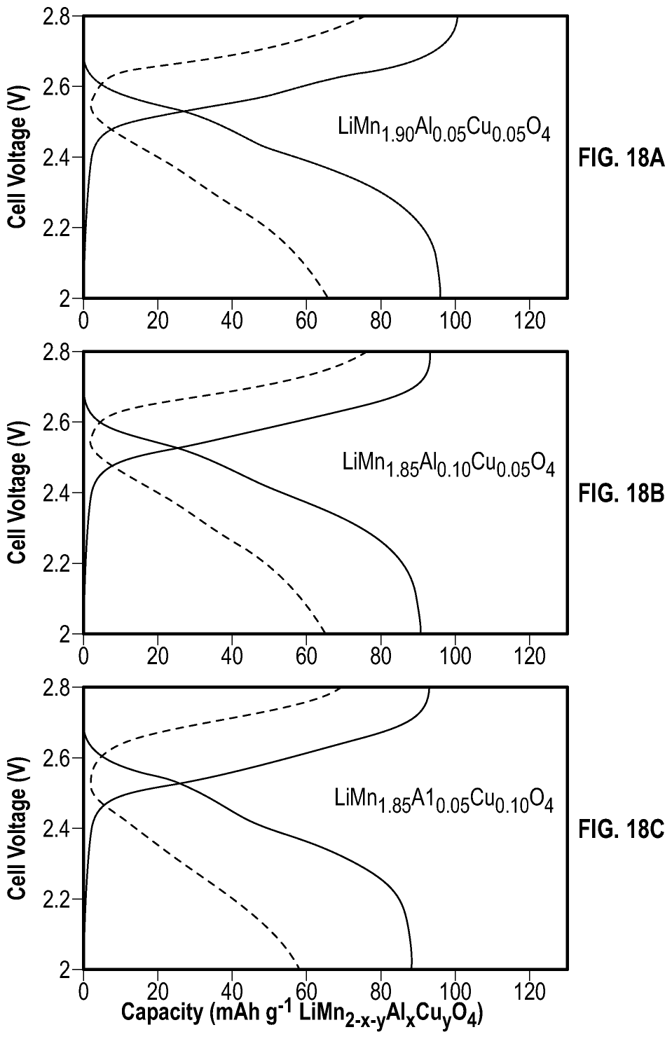

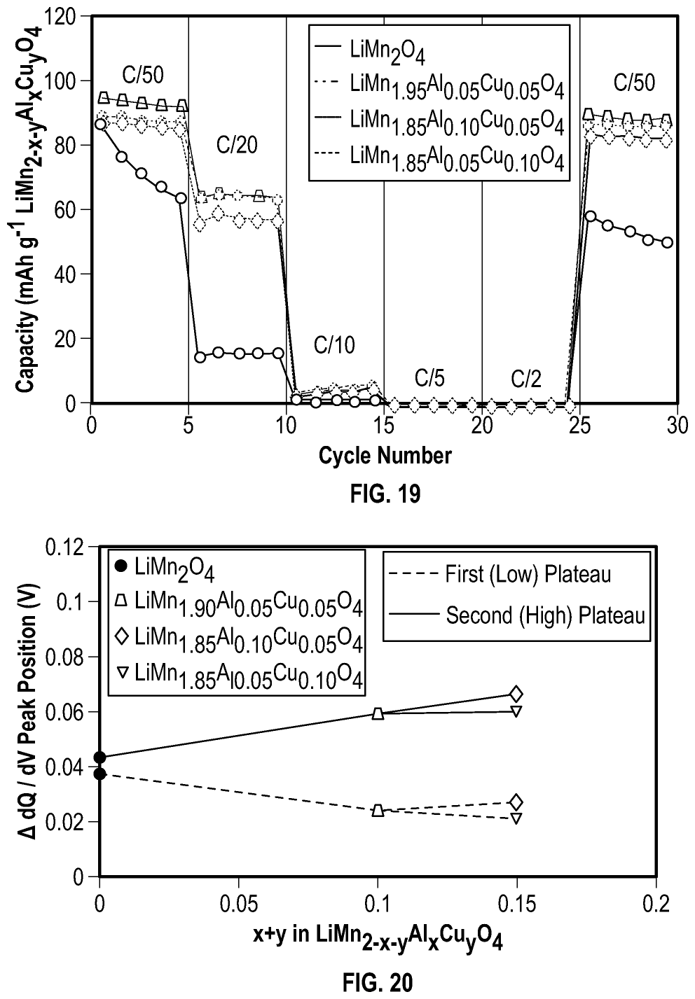

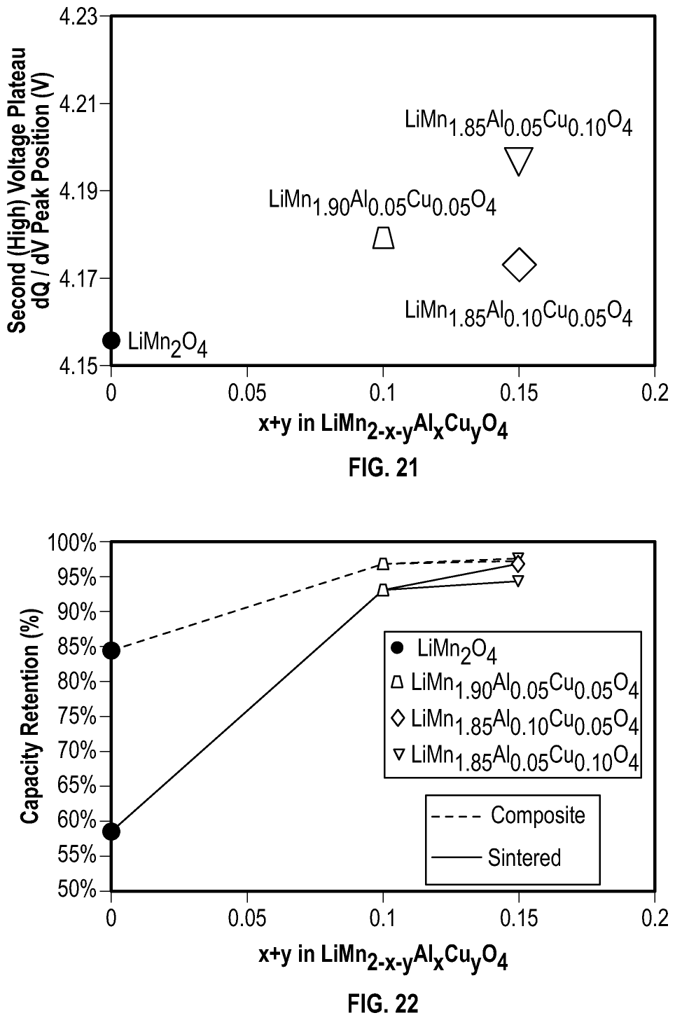

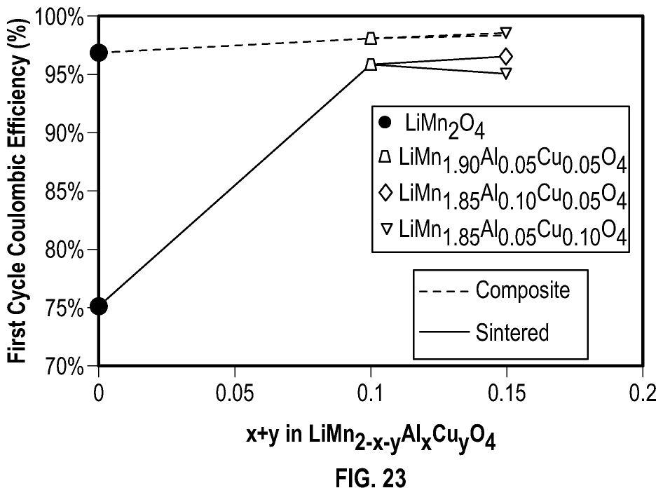

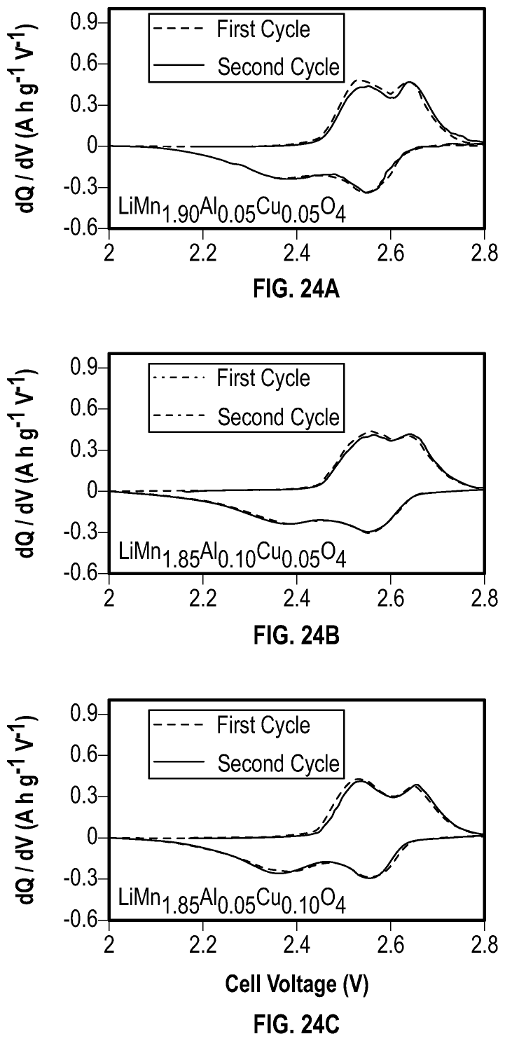

With respect to the sintered electrode cells, for the first discharge cycle at C/50 (FIG. 18), LiMn_{1.90}Al_{0.05}Cu_{0.05}O₄ reached 96 mAh g⁻¹, followed by LiMn_{1.85}Al_{0.10}Cu_{0.05}O₄ (90 mAh g⁻¹) and LiMn_{1.85}Al_{0.05}Cu_{0.10}O₄ (88 mAh g⁻¹). At C/20, LiMn_{1.90}Al_{0.05}Cu_{0.05}O₄ delivered (65 mAh g⁻¹), the best among all materials evaluated, followed by LiMn_{1.85}Al_{0.10}Cu_{0.05}O₄ (64 mAh g⁻¹) and LiMn_{1.85}Al_{0.05}Cu_{0.10}O₄ (57 mAh g⁻¹). Rate capability tests care shown in FIG. 19. When looking at the Δ dQ/dV (FIG. 20), the trend was similar to the Cu-doped samples where the Δ dQ/dV of second (high) voltage plateau increased as the dopant concentration increased. However, the magnitude of the increase was smaller than that of Cu-doped samples (FIG. 10), possibly originating from a combination between the Cu and Al, where the Al had an opposite decreasing trend for that peak with substitution (FIG. 10a). This improved electronic conductivity, coupled with the much smaller increase in second voltage plateau position (FIG. 21), were likely the major contributors to the greatest capacity being observed for LiMn_{1.90}Al_{0.05}Cu_{0.05}O₄ and LiMn_{1.85}Al_{0.10}Cu_{0.05}O₄ sintered electrodes. When looking at the retention of capacity of the last cycle from the rate capability analysis of the co-doped samples (FIG. 22), all co-doped materials in composite electrodes had retentions over 95%, and in the sintered electrodes had retentions over 93%. The first cycle CE of the co-doped materials in composite electrodes all exceeded 98%, and in sintered all exceeded 94%, the best among all materials evaluated (FIG. 23). In examining the dQ/dV of the first two cycles of the co-doped materials in sintered electrode, the dQ/dV change between the first two cycles was mitigated (FIG. 24). In summary, the co-doped materials had the most promising electrochemical properties of any of the materials evaluated when processed into sintered electrodes.

### Example 2: Anisotropic Microstructure of Electrode Material

In addition to the exploration of new materials chemistry, composition, and phase, modification as described above herein with respect to Example 1, control over the microstructure of battery electrodes also can improve the energy and power density of battery cells. In particular, alignment of the pore microstructures within Li-ion electrodes in the direction of Li⁺ flux reduces the tortuosity in the electrode microstructure, improving effective transport properties and reducing concentration polarization in the cell. Example 2 demonstrates the control of the microstructure of the electrode and the results of the same.

### Transition Metal Oxalate Dihydrate Coprecipitation Synthesis

Oxalate precipitate particles containing a transition metal (TM) of either pure Mn or Mn/Ni blends were synthesized. 100 mM of sodium oxalate (Na₂C₂O₄, Fisher Chemical) was dissolved in 400 mL of deionized (DI) water and heated to 60° C. In some cases, 10 mM of sodium citrate dihydrate (Na₃C₆O₇H₅·2H₂O, Sigma-Aldrich) was added to the dissolved Na₂C₂O₄ solution. Separately, 100 mM of soluble TM were dissolved in another 400 mL of DI water. The soluble TM composition was either 100% of manganese sulfate monohydrate (MnSO₄·H₂O, Fisher Chemical) or 81.7% of MnSO₄·H₂O/18.3% of nickel sulfate hexahydrate (NiSO₄·6H₂O, Fisher Chemical). The two solutions were then combined all at once (thus having 5 mM citrate during the reaction for cases where citrate was added) and allowed 30 min reaction time with 300 RPM stirring at 60° C. The precipitate was collected via vacuum filtration followed by rinsing of the filter cake with 1.6 L DI water. The resulting powder was then dried at 80° C. overnight in air atmosphere.

The resulting powders were TM oxalate dihydrates. For the Mn/Ni blend precursor, note that the target was an overall total 3:1 Mn:Ni stoichiometry in the precipitate particles. As will be discussed in further detail later, an excess of Mn in the solution feed was necessary to achieve this stoichiometry in the resulting particles precipitated in the presence of the citrate additive.

### Tracking of Transition Metal Concentration During Synthesis

For some experiments, the soluble concentration of each TM (Ni, Mn) was monitored as a function of time during the coprecipitation reaction. To determine the soluble TM concentration as a function of time, 1 mL of solution was drawn and filtered by 200 nm syringe filter at time points of 1, 2, 3, 5, 10, 15, 20, 25, and 30 min after initiation of the coprecipitation reaction. The total volume of the reactor was 800 mL, and thus the sum of the volumes of the samples drawn was less than 1.5% of the total reactor solution and was not expected to have a significant impact on the mixing profile or total reagent available in the reactor. After forcing the drawn liquid from the reactor through the filter, the solutions which passed through were then added to a 27.75 vol % hydrochloric acid (Sigma-Aldrich)/9.25 vol % nitric acid (Macron) aqueous solution to eliminate the possibility of precipitate formation in the filtered solution. The TM ion concentrations were then measured by ICP-OES (PerkinElmer Optima 8000). Solutions evaluated using ICP-OES had been diluted to concentrations of a few ppm of the TMs.

### Electrode Material Synthesis

Precursor produced via coprecipitation, MnC₂O₄·2H₂O and Mn_{0.75}Ni_{0.25}C₂O₄·2H₂O (relative TM composition in the solid confirmed via ICP), were blended with Li₂CO₃ (Fisher Chemical) of 5% extra stoichiometry. Blending was done by hand using mortar and pestle for 10 minutes. The mixed powder was then transferred into the furnace (Carbolite CWF 1300) and fired in an atmosphere of ambient lab air. For LMO, the temperature profile was 700° C. for 20 h. For Li₄Mn₅O₁₂, the temperature profile was 500° C. for 72 h. For LMNO, the temperature profile was at 800° C. for 6 h followed by a hold at 700° C. for 10 h. The heating rate to reach the hold temperature for all cases was 1° C. min⁻¹, and the cooling rate back to ambient temperature was not controlled.

### Material Characterization

Scanning electron micrographs (SEM) and energy dispersive x-ray spectroscopy (EDS) was conducted on powders using a FEI Quantum 650. Powder x-ray diffraction (XRD) patterns for materials were collected using a PANalytical X'pert ProMPD. Tap density was measured using a tap density analyzer (AUTOTAP, Quantachrome Instruments) by tapping 1000 times and then averaging 3 independent measurements. Brunauer-Emmett-Teller (BET) surface area was determined from N₂ adsorption isotherms collected using a NOVA 2200e Surface Area & Pore Size Analyzer (Quantachrome).

### Electrochemical Characterization

The electrode materials were mixed with acetylene black (Alfa Aesar) and polyvinylidene difluoride (PVDF, Alfa Aesar) into a slurry using N-methyl-2-pyrrolidone as a solvent with a weight ratio of 8:1:1 active material:PVDF:acetylene black. The slurry was blended in a mixer (Thinky AR-100) and then coated onto an aluminum foil using a doctor blade with 200 μm gap size. The coated film was then dried in air overnight at 80° C., followed by vacuum drying at 80° C. for 3 hours. Cathodes used in electrochemical cells were punched from the composite coated on the aluminum foil and a circular punch was used that resulted in a geometric area of 1.33 cm².

The cathode was paired with a Li foil anode of an area of 1.6 cm², and the electrodes were kept apart using Celgard 2325 separator. The electrolyte used was 1.2 M LiPF₆ in 3:7 ethylene carbonate:ethyl methyl carbonate (BASF). A coin cell (CR2032-type) was then fabricated in a glove box filled with argon (<1 ppm H₂O and O₂) and evaluated electrochemically using a multichannel battery cycler (MACCOR). Charge/discharge rates used were determined in advance using C rates based on the mass of cathode in the cells, where 1C was assumed to correspond to 148 mA g¹ LMO, 163 mA g¹ Li₄Mn₅O₁₂, and 147 mA g¹ LMNO. The electrode active material loadings were approximately 2.5 mg cm⁻² for LMO, 2.4 mg cm⁻² for Li₄Mn₅O₁₂, and 4.5 mg cm⁻² for LMNO. The voltage windows used were 3.5 V to 4.3 V (vs. Li/Li) for LMO, 1.9 V to 3.5 V (vs. Li/Li) for Li₄Mn₅O₁₂, and 3.5 V to 4.9 V (vs. Li/Li) for LMNO. Cyclic Voltammetry (CV) experiments with same voltage range as those used for galvanostatic charge/discharge cycle tests were performed using a Biologic SP-50.

Single Electrode Materials (LMO and Li₄Mn₅O₁₂) with Anisotropic Morphology Characterization

The oxalate particles were highly anisotropic, with long dimensions of ˜25 μm and thickness dimensions of ˜0.7 μm. It is noted that the citrate-free MnC₂O₄·2H₂O also had a plate morphology, although the length to thickness ratio was much less. XRD patterns were consistent with the presence of only the MnC₂O₄·2H₂O without impurity phases. The material forms a C2/c phase.

After lithiation, the secondary platelet morphology of the precursor was maintained, although there was increased internal porosity of the particles for both LMO and Li₄Mn₅O₁₂ due to the oxalate decomposition and loss of water from the solid precursor particle structure. The tap densities of LMO and Li₄Mn₅O₁₂ were 0.81±0.02 g cm⁻³ and 0.95±0.02 g cm⁻³ (standard deviations of three independent measurements). The BET surface area for LMO and Li₄Mn₅O₁₂ were calculated from N₂ adsorption isotherms (figure S3a,b) to be 5.3 m² g¹ and 20.5 m² g⁻¹.

For LMO, the resulting powder XRD pattern was consistent with prior reports for a Fd-3m phase material without any impurity phase. However, it is noted that for Li₄Mn₅O₁₂ the main peaks were consistent with prior literature reports of the formation of a Fd-3m phase, although a small impurity peak was noted at ˜33°, which was attributed to Mn₂O₃. The Li₄Mn₅O₁₂ also had broader peaks than the LMO material, suggesting relatively lower crystal grain size and/or the presence of lower crystallinity and/or defects in the material.

Anisotropic morphology controlled multicomponent TM (LiMn_{1.5}Ni_{0.5}O₄) electrode material displays SEMs of oxalate precipitates containing Ni and Mn, where the reaction conditions were identical except for the absence or presence of 5 mM of added citrate during the synthesis. The molar feed ratio of both oxalate:citrate and TM:citrate was 20:1. Precipitate particles formed in the absence of citrate had an octahedral morphology, while precipitates formed with citrate present had a platelet morphology. These plates were highly anisotropic, with thicknesses of ˜0.5 μm and widths of ˜10 μm. While the particles in were all collected after 30 min, it is noted that particles collected during the synthesis containing citrate at 5, 15, and 30 mins after initiating precipitation all had platelet morphologies, suggesting that the platelet structure was directed through selective growth of the precipitates form the early stages of the reaction. The width of the platelet particles increased as a function of time, from 5.05±0.80 μm at 5 min to 7.26±0.87 μm at 10 min (uncertainties are standard deviations based on a minimum of 30 independent particle measurements). This significant increase in the width as a function of time suggested that the crystal growth was mainly in the radial direction, which resulted in the anisotropic platelet morphology-. The results above, when combined, suggested that the citrate inhibited the growth of the Mn and Ni oxalates, and that the inhibition selectively guided the growth of the particles in the radial direction resulting in anisotropic platelet particles.

### Composition of Precipitates During Coprecipitation Reaction

Previous studies have shown that the TM composition of precipitates can significantly deviate from the feed, in particular in low concentration regimes. Compositional deviations can be due to different solubilities for different TMs and/or different rates of coprecipitation. Thus, experiments were performed to track the concentration of each TM as a function of time during the coprecipitation reaction for the case where both Mn and Ni were present to provide insights into the expected compositional homogeneity of the resulting particles. These experiments were performed both in the presence and absence of sodium citrate inhibitor that was found to direct the particles into an anisotropic platelet morphology to provide insights into whether the inhibitor had selective impacts on the rate of precipitation of the individual TMs. As mentioned herein above, the dissolved Mn:Ni ratio in the feed to the coprecipitation reaction was 4.475:1. This ratio was used because it resulted in particles with the desired total Mn:Ni 3:1 ratio for the coprecipitation process with inhibitor included after 30 minutes of reaction.

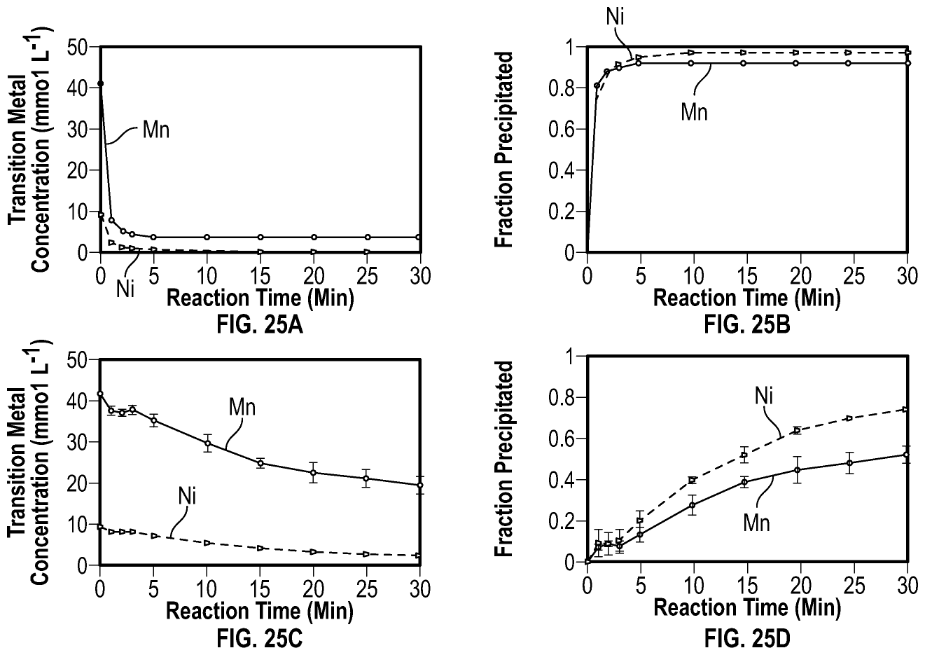

When the coprecipitation reaction was performed without inhibitor present, the soluble concentration of both Mn and Ni was measured to drop very quickly (FIG. 25). Greater than 90% of the Mn and Ni had precipitated within 3 minutes of initiation of the coprecipitation reaction (FIG. 3b). At early times during the reaction, the Mn and Ni precipitated with the same stoichiometry as the feed solution. However, at later times there was a plateau in the extent of precipitation, and the extent of precipitation of the Ni was greater than the Mn. The greater precipitation of Ni oxalate at longer times was consistent with the lower solubility of Ni oxalate relative to Mn oxalate. In addition, the observation of precipitation at the feed stoichiometry during early times of the reaction was consistent with previous measurements of TM oxalate precipitation. Even if the TM oxalates have different precipitation rates in isolation, seed particles of the faster forming precipitate can facilitate accelerating the precipitation rate of the slower forming precipitate.

The addition of 5 mM sodium citrate inhibitor resulted in significant changes to the loss of Mn and Ni from the solution phase (Figure. 25c). Both TMs precipitated much slower, confirming that the inhibitor did indeed slow the growth of the Ni and Mn oxalate particles. After 3 minutes where >90% of the TMs had precipitated in the absence of inhibitor only 11% of Mn and 8% of Ni had precipitated (FIG. 25d). At the 30 minute time point where particles were collected, the precipitation reaction done in the presence of inhibitor was still slowly proceeding, as opposed to having plateaued in the absence of inhibitor. In addition, while at the earliest times the Ni and Mn precipitated at the same stoichiometry as the TM feed, starting at ˜5 minutes and later in the process the solid that was deposited was enriched in Ni. The observation that at early reaction times the Mn and Ni precipitated at nearly the feed stoichiometry and that as time proceeded that the composition of the precipitate deposited became increasingly enriched in Ni, coupled with the observation that that the precipitate particles were platelet shaped at very early times and that the plates preferentially grew radially as a function of time suggested that the platelet precipitate particles would have a gradient in composition from Mn-rich towards the center to Ni-rich towards the edge. Further analysis was conducted to confirm whether these TM gradient particles were formed.

The root cause of the increased relative Ni may be due to the lower intrinsic solubility of the Ni oxalate (18 mg kg⁻¹ water) than Mn oxalate (310 mg kg⁻¹ water). Another possible contributing factor is the ionic radii of the Mn²⁺ (83 μm) and Ni²⁺ (69 μm) in the oxalate lattices. As mentioned earlier, the non-planar citrate ions are hypothesized to bind to the TM atoms and mimic the oxalate ions via the enriched carboxylic moieties. The TM atoms aligned in chain arrangement at the oxalate crystal surface with smaller size may impact the citrate binding, for example due to steric effects. Atoms with larger size may not only have modified steric interactions (e.g., more favorable for binding), but also might provide a more favorable surface (slightly larger and/or different surface energy) for binding by the citrate inhibitor. Crystallization growth is a dynamic process of dissolution and deposition, so TM atoms bound by oxalate ions less likely to dissolute back to solution phase than those bound by citrate ions. Thus, it may be that Ni tends to be bound and/or complexed less with citrate ions compared to oxalate ions. In addition, if we examine the nucleation phase in the first 3 minutes, the precipitation rates for both Mn and Ni were roughly the same, suggesting that in this stage the citrate behaved much less selectively, and the selectivity was more pronounced during later precipitation phases where crystal growth would be expected to play more of a role than initial nucleation with regards to loss of TM from solution.

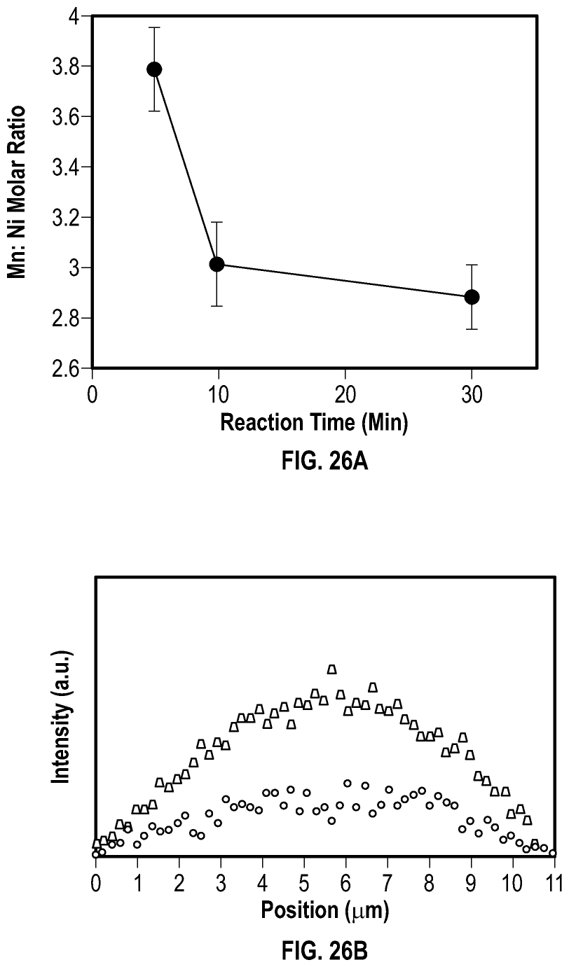

To provide further evidence that the platelet precipitate particles had compositional gradients from the center to the edge of the particle in the radial direction, EDS analysis was conducted on individual particles. First, EDS was averaged over individual platelets that were found lying flat in the SEM on particles collected at different reaction times (FIG. 26a). As the platelet width dimension increased from 5.7 to 10.5 μm, The average Mn:Ni stoichiometry decreased from 3.8:1 to 2.9:1. Note that the Mn:Ni stoichiometry dips below the 3:1 value measured for the final collected particles confirmed by dissolving the particles and conducting ICP. It was suspected this outcome was due to relatively enriched Ni deposition in the slower growing thickness direction of the particles as well. The higher sensitivity of EDS to the surface composition of the material would result in enriched Ni surface also resulting in lower Mn:Ni ratios. In any case, the growth of the particles in the radial direction coupled with the decreasing Mn:Ni ratio for the flat presented surface of the particles further supported enrichment in Ni moving from the center to the edge of the plates. In addition, EDS line scans were conducted on individual particles collected at the end of the 30 minutes of reaction. As shown in FIG. 26b, the relative Mn:Ni was lower towards the edges of the platelet and higher in the center of the platelet, providing further support that these platelet particles had a gradient in TM composition from the center to the edge of the particles. Coprecipitation precursor particles for battery cathode materials have previously been intentionally synthesized to take advantage of different desirable properties of the compositions of the core region compared to the surface. In these previous reports, the composition gradient was tailored by modifying the dissolved TM feed stoichiometry as a function of time. However, in this present case the gradient resulted from differences in the intrinsic rates of precipitation of the different TM for the solution conditions present. The synthesis strategy reported herein may provide a new route towards TM precursor particles with both compositional gradients and diverse morphologies.

It is noted that while there was a gradient observed in the radial dimension in the Mn and Ni distribution, EDS maps on individual particles suggested that the Mn and Ni were co-located throughout the particles. In addition, the XRD pattern of the Mn_{0.75}Ni_{0.25}C₂O₄·2H₂O precipitates did not have any noticeable impurity phases. These results provided evidence that there were not local impurity phases or local grains with deviating Ni and Mn compositions, and that while there was a compositional gradient for the overall particle that at a more local level that the phase and composition was uniform. It is possible that the distribution of Mn and Ni formed a solid solution throughout the precipitate particle.

While the anisotropic platelet precursors with compositional gradients could be beneficial for some materials, the target composition in this study was a 3:1 Mn:Ni ratio throughout the particles to produce the desired LMNO active material. Achieving the 3:1 Mn:Ni target is helpful to achieve high electrochemical capacity at high voltage for the LMNO. The high voltage capacity in LMNO results from the Ni^{2+/4+} redox couple. If the material was enriched in Mn, then the excess Mn would result in Mn^{3+/4+} redox couple participation at a lower voltage than the Ni redox. It is noted that in some cases Mn redox has been reported to be desirable to LMNO due to increased rate capability of the active material. If the active material was enriched in Ni (holding the total TM content constant), the excess Ni increases the likelihood of the formation of rock salt impurity phases, which has previously been demonstrated to degrade electrochemical performance and structural stability of the material with intercalation/deintercalation. Although a gradient in composition was found in the precursor material, the overall total Mn:Ni TM ratio was still 3:1. Thus, when the precursor was blended with a Li source and fired in air, the firing time was chosen to be long enough to facilitate migration of the TM species to achieve homogeneous distribution in the TM oxide active material.

After firing and converting the precursor to LMNO active material, no peaks were observed that suggested the formation of impurity phases, including rock salt impurities. The lattice parameter, assuming the P4₃32 crystal structure, was calculated to be a=b=c=8.1643 Å and α=β=γ=90°. The LMNO retained the anisotropic platelet secondary particle morphology of the precursor, although the firing process resulted in internal porosity in the particles. This porosity has been previously observed with precipitate precursor particles and oxalates in particular. and has been attributed to voids formed when the water and oxalate leave the precursor during firing as also mentioned for the LMO and Li₄Mn₅O₁₂ materials earlier. The bulk composition of the LMNO was confirmed to have a 3:1 Mn:Ni TM stoichiometry using ICP.

To provide support that the firing conditions homogenized the compositional gradient in the platelet particles, EDS line scans were conducted on particles that were found lying flat in the SEM. As can be seen in a representative example in, the compositional profile was much more consistent from the core towards the edge compared to the precursor particles. The material spent a total of 16 h at temperatures exceeding 700° C., allowing the gradient in composition to relax and become more homogeneous. It is noted that the edges of the line scan appear to have gradients in composition, although the effects of being near the edge of the particle and having increasing contributions from the background substrate in the SEM make it difficult to conclude that there was a gradient remaining in these regions. The tap density for the material powder was measured to be 0.61±0.02 g cm⁻³ (standard deviation of 3 independent measurements), and the BET surface area was 2.9 m² g⁻¹.

Electrochemical evaluations of LMO, Li₄Mn₅O₁₂, LMNO

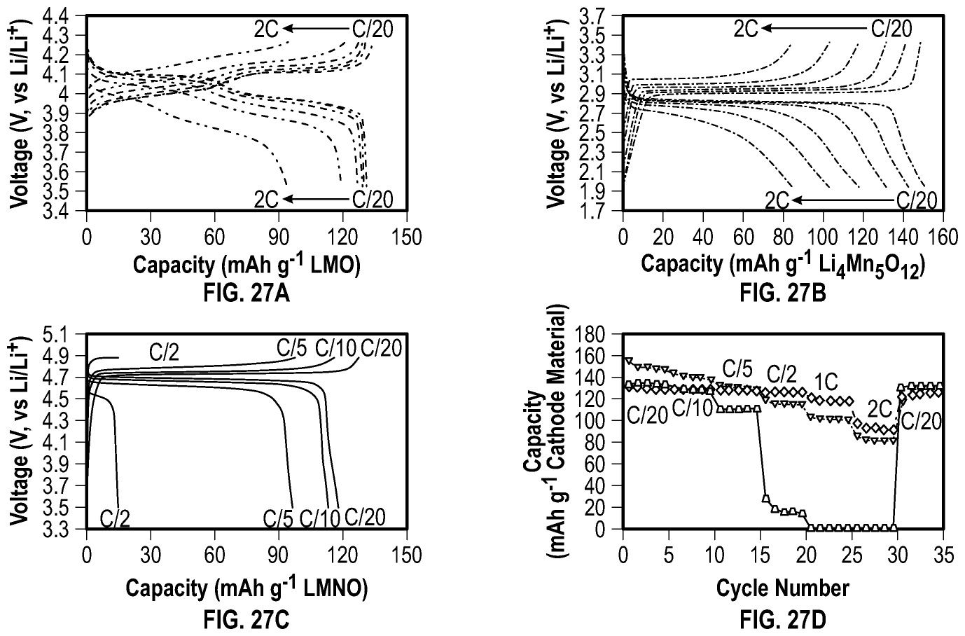

The voltage profile taken from the second cycle at each rate of the 3 materials paired with Li foil during rate capability cycling experiments is provided in FIG. 6. The discharge profile of LMO at C/20 had 2 distinct characteristic voltage plateaus at 4.1 V (two-phase reaction between λ-MnO₂ and Li_{0.5}Mn₂O₄) and at 4.0 V (single phase reaction between Li_{0.5}Mn₂O₄ and LiMn₂O₄), reducing the averaged Mn oxidation state from 4+ back to 3.5+. The slow rate capacity reached more than 130 mAh g⁻¹ LMO with first cycle coulombic efficiency of ˜97%, and at 2 C, the capacity still maintained ˜95 mAh g⁻¹ (FIG. 27).

For Li₄Mn₅O₁₂, the single discharge voltage plateau at ˜2.9 V was observed, suggesting that with partially substituted Mn by Li at 16c sites and increase in initial oxidation state of Mn (ideally 4+), the electrochemical activity shifted from 4 V down to ˜3 V. The first C/20 discharge reached over 150 mAh g¹ (out of theoretical 163 mAh g⁻¹) with coulombic efficiency of ˜96%, and at 2 C, ˜85 mAh g⁻¹ was retained (FIG. 27b). Both single Mn-based cathode materials exhibited good capacity and rate capability.

For multi-TM-based material LMNO with high compositional uniformity (FIG. 27c), at C/20, a very high fraction (>94%) of the discharge capacity was >4.5 V and there was a relatively small amount of capacity near ˜4.1 V, indicating that most of the capacity resulted from Ni redox and not Mn redox. The high amount of Ni redox and high voltage capacity indicated achieving the desired 3:1 Mn:Ni ratio in the active material and a high level of ordering of the Ni in the structure. At C/2, the limited capacity was attributed to (i) the upper cutoff voltage (4.9 V vs. Li/Li⁺) was being close to the operating voltage (4.7 V˜4.8 V) to prevent electrolyte decomposition (and thus greater polarization at higher rates hit the cutoff voltage before extracting high fractions of the capacity); (ii) the high operating voltage resulted in more electrolyte degradation and thicker solid-electrolyte interphase formation relative to LMO and Li₄Mn₅O₁₂, which likely contributed to the relatively lower initial coulombic efficiency compared to the other electrode materials in this report of 84%; and (iii) the high degree of cation ordering in the material may have lowered the relative rate capability.

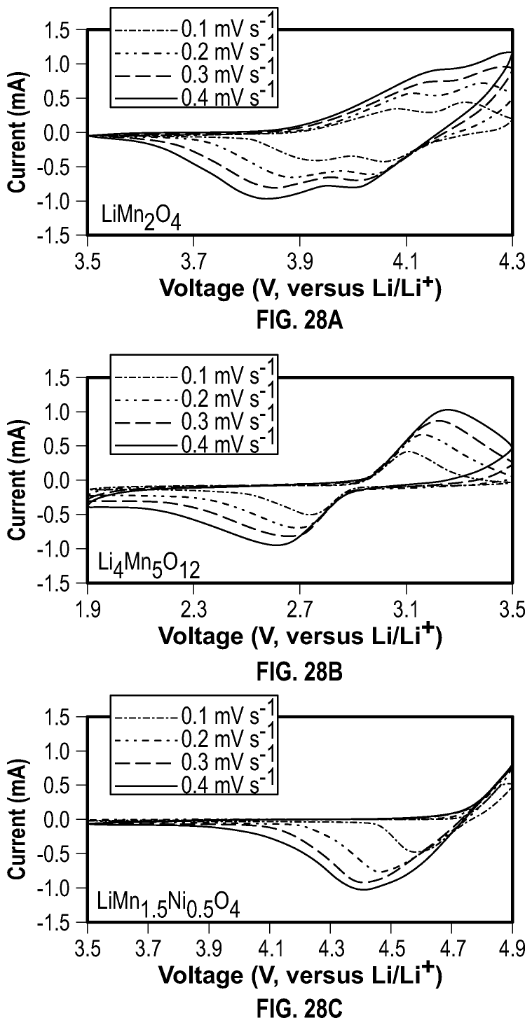

CV profiles at four different scan rates for each material can be found in FIG. 28. For LMO and Li₄Mn₅O₁₂, the peaks in the CV profiles were consistent with the voltages where plateaus were observed during galvanostatic charge/discharge of the same materials (FIG. 27). For LMNO, only one reduction peak was observed in CV, which was attributed to the relatively fast scan rate and the small voltage interval between the two voltages associated with the Ni^{2+/3+} and Ni^{3+/4+} redox couples. Two distinctive peaks were observed, as well as a small lower voltage peak attributed to a small amount of Mn³⁺ redox capacity. Thus, the individual redox processes being observed in dQ/dV suggested the lack of distinguishing them in CV may have been due to the scan rate applied. The peak current densities versus square root of scan rates were plotted (figure S9) to estimate the solid state diffusivity of Li⁺ for each material. LMO, Li₄Mn₅O₁₂, and LMNO were calculated using the slope of these fitted plots to be 4.4×10⁻¹¹ cm² s⁻¹, 2.9×10⁻¹¹ cm² s⁻¹, and 3.9×10⁻¹¹ cm² s⁻¹. The peak current densities versus scan rates were plotted to provide insights into the relevant electrochemical processes (either capacitive with slope of 1 or Faradaic with slope of 0.5). The slopes for LMO, Li₄Mn₅O₁₂, and LMNO were 0.65, 0.51, and 0.56, which would suggest primarily faradic reactions.

Cycle life tests with lithium foil anode were conducted at both C/5 and 2 C rate, with the same rate applied for both charge and discharge. For LMO, at C/5, the capacity at the 50^{th} discharge was ˜119 mAh g⁻¹, ˜96% of the peak capacity in the cycle life test; at 2 C, the capacity at the 500^{th} discharge was ˜84 mAh g⁻¹, ˜75% of the peak capacity in the cycle life test. For Li₄Mn₅O₁₂, at C/5, the capacity at the 50^{th} discharge was ˜111 mAh g⁻¹, ˜73% of the peak capacity in the cycle life test; at 2 C, the capacity at the 500^{th} discharge was 63 mAh g⁻¹, ˜59% of the peak capacity in the cycle life test. For LMNO, at C/5, the capacity at the 50^{th} discharge was ˜116 mAh g⁻¹, ˜93% of the peak capacity in the cycle life test. These results suggest good cycle life for the LMO at both rates, and also for the LMNO at relatively low rates of charge/discharge.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### EXEMPLARY ASPECTS

The following exemplary aspects are provided, the numbering of which is not to be construed as designating levels of importance:
Aspect 1 provides an electrochemical storage device sintered electrode, comprising:
a doped or undoped LiMn₂O₄, wherein the doped or undoped LiMn₂O₄ comprises at least 95 wt % of the sintered electrode;
a coated LiMn₂O₄ substrate; or both.
Aspect 2 provides the electrochemical storage device sintered electrode of Aspect 1, wherein the doped LiMn₂O₄ comprises one dopant.
Aspect 3 provides the electrochemical storage device sintered electrode of any one of Aspects 1 or 2, wherein the doped LiMn₂O₄ comprises at least two dopants.
Aspect 4 provides the electrochemical storage device sintered electrode of any one of Aspects 1-3, wherein the at least one dopant has a 1⁺, 2⁺, or 3⁺ oxidation state.
Aspect 5 provides the electrochemical storage device sintered electrode of any one of Aspects 1-4, wherein the at least one dopant comprises copper, aluminum, sulfur, potassium, or a mixture thereof.
Aspect 6 provides the electrochemical storage device of any one of Aspects 1-5, wherein the coated LiMn₂O₄ comprises one metal coating.
Aspect 7 provides the electrochemical storage device of any one of Aspects 1-6, wherein the coated LiMn₂O₄ comprises at least two metal coatings.
Aspect 8 provides the electrochemical storage device of any one of Aspects 6 or 7, wherein the metal coating comprises at least one metal having a 1⁺, 2⁺, or 3⁺ oxidation state.
Aspect 9 provides the electrochemical storage device of any one of Aspects 6-8, wherein the metal comprises copper, aluminum, sulfur, potassium, or a mixture thereof.
Aspect 10 provides the electrochemical storage device of any one of Aspects 1-9, wherein the coating covers from about 10% to about 100% of a total surface area of the LiMn₂O₄ substrate.
Aspect 11 provides the electrochemical storage device of any one of Aspects 1-10, wherein the coating covers from about 10% to about 50% of a total surface area of the LiMn₂O₄ substrate.
Aspect 12 provides the electrochemical storage device sintered electrode of any one of Aspects 1-11, wherein the doped LiMn₂O₄ comprises Formula I:

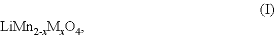

wherein M=Cu, Al, or a mixture thereof and x is in a range of from 0 to 0.16.
Aspect 13 provides the electrochemical storage device sintered electrode of any one of Aspects 6-12, wherein x is in a range of from 0 to 0.15.
Aspect 14 provides the electrochemical storage device sintered electrode of any one of Aspects 6-13, wherein x is in a range of from 0 to 0.10.
Aspect 15 provides the electrochemical storage device sintered electrode of any one of Aspects 6-14, wherein the doped LiMn₂O₄ comprises Formula II:

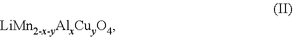

wherein x and y are independently in a range of from about 0.01 to about 0.15.
Aspect 16 provides the electrochemical storage device sintered electrode of Aspect 15, wherein x and y are independently in a range of from about 0.01 to about 0.13.
Aspect 17 provides the electrochemical storage device sintered electrode of any one of Aspects 15 or 16, wherein x and y are independently in a range of from about 0.01 to about 0.095.
Aspect 18 provides the electrochemical storage device sintered electrode of any one of Aspects 1-17, wherein the sintered electrode is a battery cathode.
Aspect 19 provides the electrochemical storage device sintered electrode of any one of Aspects 1-18, wherein the sintered electrode is free of a binder, an inactive solid additive, or a mixture thereof.
Aspect 20 provides the electrochemical storage device sintered electrode of any one of Aspects 1-19, wherein the sintered electrode comprises a spinel crystal structure.
Aspect 21 provides an electrochemical storage device sintered electrode, comprising:

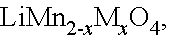

wherein M=Cu, Al, or a mixture thereof and x is in a range of from 0 to 0.16.
Aspect 22 provides the electrochemical storage device sintered electrode of Aspect 21, wherein x is in a range of from 0 to 0.15.
Aspect 23 provides the electrochemical storage device sintered electrode of any one of Aspects 21 or 22, wherein x is in a range of from 0 to 0.10.
Aspect 24 provides a lithium ion battery comprising: a sintered electrode comprising LiMn_{2-x-y}AlₓCu_{y}O₄,
wherein x and y are independently in a range of from about 0.03 to about 0.13.
Aspect 25 provides the lithium ion battery of Aspect 24, wherein x and y are independently in a range of from about 0.05 to about 0.10.
Aspect 26 provides the lithium ion battery of Aspect 24 or 25, wherein x and y are independently in a range of from about 0.05 to about 0.95.
Aspect 27 provides a lithium ion battery comprising:
a first electrode corresponding to the sintered electrode of any one of Aspects 1-26;
a second electrode spaced apart from the first electrode;
an electrolyte in contact with the first electrode and the second electrode; and
a separator positioned between the first electrode and the second electrode.
Aspect 28 provides the lithium ion battery of Aspect 27, wherein the second electrode comprises lithium metal, Li₄Ti₅O₁₂, graphite, or a mixture thereof.
Aspect 29 provides the lithium ion battery of any one of Aspects 27 or 28, wherein the electrolyte comprises a salt.
Aspect 30 provides the lithium ion battery of any one of Aspects 27-29, wherein the separator comprises a porous polymer or glass fiber impregnated with electrolyte.
Aspect 31 provides the lithium ion battery of Aspect 30, wherein the polymer comprises a polyurethane, a polypropylene, a polyethylene, a copolymer thereof, or a mixture thereof.
Aspect 32 provides a method of making the sintered electrode of any one of Aspects 1-31, the method comprising:
contacting manganese oxalate, lithium carbonate, and the at least one dopant, to form a doped LiMn₂O₄ electroactive material; and
sintering the doped LiMn₂O₄ material to form the sintered electrode.
Aspect 33 provides the method of Aspect 32, wherein sintering is performed at a temperature in range of from about 500° C. to about 1100° C.
Aspect 34 provides the method of any one of Aspects 32 or 33, wherein sintering is performed at a temperature in range of from about 700° C. to about 900° C.
Aspect 35 provides the method of any one of Aspects 32-34, wherein sintering is performed at a variable temperature.
Aspect 36 provides the method of any one of Aspects 32-35, wherein sintering is performed over a period of time in a range of from about 0 hours to about 20 hours.
Aspect 37 provides the method of any one of Aspects 32-36, wherein sintering is performed over a period of time in a range of from about 12 hours to about 18 hours.
Aspect 38 provides the method of any one of Aspects 32-37, wherein the dopant is a metal oxide.
Aspect 39 provides the method of any one of Aspects 32-38, wherein the dopant comprises CuO, Al₂O₃, or a mixture thereof.
Aspect 40 provides the method of any one of Aspects 32-39, wherein the manganese oxalate is a first manganese oxalate and the method further comprises contacting the first manganese oxalate, the lithium carbonate, and the at least one dopant with a second manganese oxalate, the second manganese oxalate being doped with nickel.
Aspect 41 provides the method of Aspect 40, wherein the first manganese oxalate comprises Formula (III),

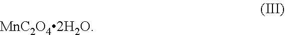

Aspect 42 provides the method of any one of Aspects 40 or 41, wherein the second manganese oxalate comprises Formula IV:

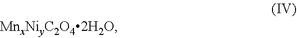

wherein the sum of x and y=1.
Aspect 43 provides the method of Aspect 42, wherein x is greater than y.
Aspect 44 provides the method of any one of Aspects 42 or 43, wherein the second manganese oxalate comprises Formula V:

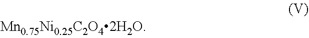

Aspect 45 provides a method of making the sintered electrode of any one of Aspects 1-44, the method comprising:
contacting a first manganese oxalate, a second manganese oxalate that is doped with nickel, a lithium carbonate, and the at least one dopant at an elevated temperature, to form a doped, LiMn₂O₄ precursor;
blending the doped LiMn₂O₄ precursor to form a blended doped LiMn₂O₄ precursor;
sintering the blended doped LiMn₂O₄ precursor to form the sintered electrode.
Aspect 46 provides the method of Aspect 45, wherein sintering is performed at a temperature in range of from about 500° C. to about 1100° C.
Aspect 47 provides the method of any one of Aspects 45 or 46, wherein sintering is performed at a temperature in range of from about 700° C. to about 900° C.
Aspect 48 provides the method of any one of Aspects 45-47, wherein sintering is performed at a variable temperature.
Aspect 49 provides the method of any one of Aspects 45-48, wherein sintering is performed over a period of time in a range of from about 0 hours to about 20 hours.
Aspect 50 provides the method of any one of Aspects 45-49, wherein sintering is performed over a period of time in a range of from about 16 hours to about 18 hours.
Aspect 51 provides the method of any one of Aspects 45-50, wherein the dopant is a metal oxide.
Aspect 52 provides the method of any one of Aspects 45-51, wherein the dopant comprises CuO, Al₂O₃, or a mixture thereof.
Aspect 53 provides the method of any one of Aspects 45-52, wherein the first manganese oxalate comprises Formula (III),

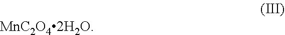

Aspect 54 provides the method of Aspect 53, wherein the second manganese oxalate comprises Formula IV:

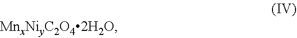

wherein x+y=1.
Aspect 55 provides the method of Aspect 54, wherein x is greater than y.
Aspect 56 provides the method of any one of Aspects 54 or 55, wherein the second manganese oxalate comprises Formula V:

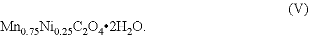

Aspect 57 provides the electrochemical storage device sintered electrode of any one of Aspects 1-56, wherein the electrochemical storage device comprises a lithium ion battery.
Aspect 58 provides an article comprising the electrochemical storage device of any one of Aspects 1-57.
Aspect 59 provides the article of Aspect 58, wherein the article comprises a vehicle or an electronic device.
Aspect 60 provides a method of improving a material stability, electronic conductivity, or both of sintered electrode, the method comprising doping or coating the sintered electrode with a metal dopant.

1. An electrochemical storage device sintered electrode, comprising:
a doped or undoped LiMn₂O₄, wherein the doped or undoped LiMn₂O₄ comprises at least 95 wt % of the sintered electrode;
a coated LiMn₂O₄ substrate; or
both.

2. The electrochemical storage device sintered electrode of claim 1, wherein the doped LiMn₂O₄ comprises one dopant.

3. The electrochemical storage device sintered electrode of claim 1, wherein the doped LiMn₂O₄ comprises at least two dopants.

4. The electrochemical storage device sintered electrode of claim 1, wherein the at least one dopant has a 1⁺, 2⁺, or 3⁺ oxidation state.

5. The electrochemical storage device sintered electrode of claim 1, wherein the at least one dopant comprises copper, aluminum, sulfur, potassium, or a mixture thereof.

6. The electrochemical storage device of claim 1, wherein the coated LiMn₂O₄ comprises one metal coating.

7. The electrochemical storage device of claim 1, wherein the coated LiMn₂O₄ comprises at least two metal coatings.

8. The electrochemical storage device of claim 6, wherein the metal coating comprises at least one metal having a 1⁺, 2⁺, or 3⁺ oxidation state.

9. The electrochemical storage device of claim 6, wherein the metal comprises copper, aluminum, sulfur, potassium, or a mixture thereof.

10. The electrochemical storage device of claim 1, wherein the coating covers from about 10% to about 100% of a total surface area of the LiMn₂O₄ substrate.

11. The electrochemical storage device of claim 1, wherein the coating covers from about 10% to about 50% of a total surface area of the LiMn₂O₄ substrate.

12. The electrochemical storage device sintered electrode of claim 1, wherein the doped LiMn₂O₄ comprises Formula I: 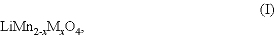
wherein M=Cu, Al, or a mixture thereof and x is in a range of from 0 to 0.16.

13. The electrochemical storage device sintered electrode of claim 6, wherein x is in a range of from 0 to 0.15.

14. The electrochemical storage device sintered electrode of claim 6, wherein x is in a range of from 0 to 0.10.

15. The electrochemical storage device sintered electrode of claim 6, wherein the doped LiMn₂O₄ comprises Formula II: 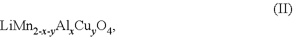
wherein x and y are independently in a range of from about 0.01 to about 0.15.

16. The electrochemical storage device sintered electrode of claim 15, wherein x and y are independently in a range of from about 0.01 to about 0.13.

17. The electrochemical storage device sintered electrode of claim 15, wherein x and y are independently in a range of from about 0.01 to about 0.095.

18. The electrochemical storage device sintered electrode of claim 1, wherein the sintered electrode is a battery cathode.

19. The electrochemical storage device sintered electrode of claim 1, wherein the sintered electrode is free of a binder, an inactive solid additive, or a mixture thereof.

20. The electrochemical storage device sintered electrode of claim 1, wherein the sintered electrode comprises a spinel crystal structure.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)
